(19) United States
(12) Patent Application Publication
(10) Pub. No.: US 2026/0278807 A1
(43) Pub. Date: Sep. 17, 2026

(54) SYSTEM AND METHODS FOR REAL-TIME CLASS-BASED INFERENCE AND ADAPTIVE SYSTEM CONTROL

(71) Applicant: SmartStreet Al, Inc., New York, NY (US)

(72) Inventors: Tommy Inouye, Long Island City, NY (US); Alexander Papathomas, New York, NY (US)

(73) Assignee: SmartStreet Al, Inc., New York, NY (US)

(21) Appl. No.: 19/532,061

(22) Filed: Feb. 6, 2026

Related U.S. Application Data
(60) Provisional application No. 63/754,617, filed on Feb. 6, 2025.

(51) Int. Cl. G06T 7/20; G06N 3/0464; G06V 10/25; G06V 20/52

(52) U.S. Cl. CPC G06T 7/20; G06N 3/0464; G06V 10/25; G06V 20/53; G06T 2207/30241; G06V 2201/07

(57) ABSTRACT

A computer-implemented system and method are disclosed for monitoring and analyzing congestion trends using video-derived spatial analytics. Video data from live streams, camera-based sources, or recorded footage is processed at an edge device that performs frame-level preprocessing, object detection, region filtering, feature association, and multi-frame tracking. Structured inference artifacts, including object locations, motion vectors, and track identifiers, are stored and transmitted as metadata without requiring transmission or persistent storage of raw video. A data ingestion service aggregates tracking results across time and regions of interest, applies anomaly filtering to remove corrupted or unreliable data segments, and generates congestion metrics and predictive outputs. Spatial masks define flexible regions of interest, enabling multiple independent analytics streams from a single video source with reduced computational overhead. The architecture supports both real-time and batch processing modes while improving latency, processor utilization, and scalability for large-scale deployment across heterogeneous environments.

### CROSS-REFERENCE TO RELATED APPLICATIONS

This application is a U.S. Non-Provisional Utility Patent Application entitled, “SYSTEM AND METHODS FOR REAL-TIME CLASS-BASED INFERENCE AND ADAPTIVE SYSTEM CONTROL”, which claims priority to co-pending U.S. Provisional Patent Application No. 63/754,617, filed on Feb. 6, 2025, entitled, “SYSTEM AND METHODS FOR OFFERING ON SITE REAL TIME ADVERTISEMENTS WITH THE USE OF A SCREEN”, the contents of which are hereby fully incorporated by reference.

### FIELD

This invention relates to image analysis, video sensing systems, and data processing for understanding movement, activity, and object presence within physical environments, which aligns with USPTO Class 348, directed to television and video systems, and Class 701, directed to data processing for traffic and movement monitoring. In particular, the field further intersects with Class 706, directed to Artificial Intelligence, due to the implementation of machine learning techniques for preprocessing, object detection, and multi-frame inference.

### BACKGROUND

Current visual monitoring and perception systems deployed in physical environments exhibit significant technical limitations that reduce their accuracy, reliability, and suitability for both analytical and real-time decision-driven applications. In particular, many such systems are unable to consistently detect and classify objects in real time under operating conditions, including variations in illumination, weather, camera viewpoint, and scene density. As activity levels within an environment fluctuate, these systems frequently experience degraded performance characterized by increased false detections, missed detections, or unstable classification outputs.

A further technical shortcoming of existing systems is the inability to reliably associate detected objects across successive frames or time intervals. As a result, many systems cannot determine whether objects observed at different points in time correspond to the same physical entities or to distinct instances, limiting their effectiveness for post-analysis, temporal aggregation, trend estimation, or validation of historical inference data. This lack of temporal consistency reduces confidence in derived metrics and constrains the ability of such systems to support applications requiring stable counting, trajectory analysis, or longitudinal observation.

These limitations reduce the reliability of inference outputs required by downstream systems that depend on timely and context-aware signals. In addition, many existing systems are constrained to a limited and static set of classification categories, making it difficult to adapt such systems to new or application-specific object classes without substantial reconfiguration or retraining. Another technical limitation is the lack of adaptability to location-specific variations within a monitored environment, where small changes in camera viewpoint, scene layout, or object flow patterns can lead to disproportionate changes in reported metrics. In some illustrative scenarios, inference outputs may overrepresent activity in frequently traversed regions of a scene while underrepresenting activity in other areas, or fluctuate unpredictably as objects enter and exit the field of view. In other scenarios, systems may repeatedly count the same object as multiple distinct instances over time or fail to maintain continuity between observations separated by brief occlusions or temporal gaps. These deficiencies are particularly problematic in application domains where accurate, stable, and low-latency interpretation of visual activity is required, including but not limited to surveillance systems, physical-environment analytics, real-time content control, occupancy monitoring, and other automated decision or control systems operating in environments. As a result, outputs generated by such systems are often insufficient for driving precise, localized, and responsive decisions, and make it difficult to derive stable, actionable insights from environments characterized by non-uniform activity patterns.

Many systems also lack the ability to segment and analyze specific regions of interest within a single camera feed. Without this capability, analysis often aggregates data indiscriminately, producing results that do not accurately reflect localized conditions. For instance, a camera positioned to monitor a crosswalk may also capture activity in an adjacent park or bus stop, conflating unrelated data points. While some systems use masking techniques to mitigate these biases by creating flexible boundaries for object detection algorithms, implementing such features at scale remains a challenge, as masking logic is often statically configured and difficult to adapt to changing environmental conditions or application requirements. Although masking can enable metrics for different sections of a video feed to be analyzed independently, the complexity of configuring, deploying, and maintaining such logic across multiple locations frequently deters widespread adoption. Moreover, even when segmentation is achieved, many systems are unable to propagate region-specific inference results in a form that can be reliably consumed in real time by downstream systems. Scalability further remains a pressing issue, as many monitoring systems rely on costly, hardware-intensive solutions and face significant configuration, maintenance, and integration burdens when deployed at scale. These challenges are compounded by limited interoperability with legacy systems, resulting in fragmented workflows, delayed responses, and underutilization of data in applications requiring timely, context-aware operation within physical environments.

Further, the inability to adequately address privacy concerns significantly hampers the adoption of many visual monitoring systems. In urban and commercial environments where public and semi-public spaces are subject to continuous observation, data protection regulations and public sensitivity to surveillance impose substantial technical and operational constraints. Many existing systems lack built-in mechanisms to anonymize visual data at the point of capture or processing, resulting in the collection or retention of information that may expose individuals to identification or tracking. As a result, such systems face increased legal, ethical, and compliance risks, limiting their suitability for applications that require real-time analysis or content decisioning within physical environments. Together, these challenges underscore the need for solutions that integrate privacy-preserving techniques directly into the visual analysis pipeline while maintaining operational effectiveness.

### SUMMARY

The system for analyzing visual data captured within physical environments is configured to enhance its flexibility, privacy, and scalability for both analytical and real-time decision-driven applications. It uses tracking of flexible shapes, employing masking techniques to address location-based biases within a single camera feed, such as camera proximity to crowded areas. These masks enable targeted object detection, allowing the system to focus on custom-defined detected objects associated with a particular use case and generate separate metrics or inference outputs for different areas of a street, despite using a single camera feed. The system further supports configurable classification and tracking of detected objects into one or more model-defined classes, enabling such objects to be selectively tracked and targeted based on application-specific requirements and enabling inference results to be consumed by downstream systems. In terms of privacy, the system is designed to anonymize visual data during processing and ensures that no Personally Identifiable Information (PII) is collected or stored. Video footage is processed only for defined operational purposes and is immediately deleted after data ingestion.

The system features edge processing capabilities with a custom-designed camera that performs video processing directly on the device. This approach reduces the need for cloud-based processing, lowering latency and bandwidth costs while enhancing privacy and enabling faster real-time decision-making. The system is also camera-agnostic, supporting both real-time and non-real-time video analysis. It is adaptable to a variety of video sources with differing frame rates, resolutions, and environmental conditions, ensuring consistent performance across diverse settings. A multi-stage detection architecture utilizing custom detection models is employed to detect and classify objects into one or more model-defined classes, infer object attributes or behaviors, and perform additional perception tasks simultaneously. This architecture allows for detailed, context-sensitive analysis and is highly extensible. New models and data types can be easily integrated, supporting a wide range of use cases, including class-based targeting, pedestrian monitoring, vehicle congestion, content selection, and other real-time, inference-driven applications. In some embodiments, the device is further configured to emit real-time inference signals or control messages that can be consumed by external content playback systems or ad players, including systems executing on the same device, enabling low-latency, on-device or distributed content control.

The system further incorporates an object tracking pipeline that leverages state-of-the-art tracking algorithms to associate detected objects across successive frames and over time, enabling accurate trajectory estimation in dynamic environments. Tracking performance is enhanced through rapid selection and optimization of tracking parameters tailored to specific deployment environments or sites, allowing the system to maintain object identity in high-density, low-visibility, or rapidly changing conditions. In some embodiments, new deployments may be optimized almost immediately through a structured auditing process that validates tracking outputs against observed conditions, followed by automated or semi-automated hyperparameter optimization techniques that perform an exhaustive or near-exhaustive search to identify optimal tracking configurations. In certain use cases, the tracking pipeline may be augmented with feature representations or embedding vectors extracted from video frames, which can be propagated through the tracking process on the device or within downstream processing stages to further enhance object association accuracy. Anomaly detection mechanisms may be applied to tracking outputs to identify and remediate disruptions caused by environmental changes, sensor interruptions, or operational faults. The tracking architecture is designed to be modular and extensible, supporting the integration of new tracking algorithms, feature extraction methods, or optimization strategies, and enabling reliable tracking outputs for a wide range of real-time, inference-driven applications.

In some aspects, the techniques described herein relate to a method, including: acquiring, by one or more processors of an edge-enabled electronic device, video frames representing an environment, wherein acquiring includes at least one of (i) capturing the video frames using an image sensor of the edge-enabled electronic device or (ii) receiving the video frames from an external video source; obtaining, by the one or more processors, a configuration that defines one or more regions of interest, each specified by a respective polygonal boundary in image coordinates, and one or more model-defined object classes of interest; preprocessing, by the one or more processors, the video frames to normalize one or more input characteristics, including at least one of resolution, frame rate, or color characteristics; executing, by the one or more processors, at least one object detection model to produce, for a given frame, a set of detections, each including a location and a class label; filtering, by the one or more processors, the detections to determine, for each region of interest, an in-bound subset of detections that match at least one of the model-defined object classes of interest and satisfy a spatial inclusion test with respect to the polygonal boundary of the region of interest; associating, by the one or more processors, and for each region of interest, detections across successive frames to maintain track identities over a temporal window without storing raw video frames, wherein associating includes computing an association cost using at least motion consistency and a detection history over the temporal window, and wherein associating applies class-aware tracking parameters that vary at least one of a matching threshold, a track initiation threshold, or a track persistence buffer based on an object class; generating, by the one or more processors, separate region-specific inference outputs for the regions of interest, the region-specific inference outputs including, for each region of interest, metrics derived from a plurality of detected objects within the region of interest, the metrics including at least one of object counts, flow direction, dwell time, or entry/exit events; and emitting, by the one or more processors, at least one real-time inference signal derived from at least one of the region-specific inference outputs to a downstream system configured to control or influence an operation within the environment.

In some aspects, the techniques described herein relate to an electronic device, including: an image sensor configured to capture video frames representing an environment; one or more processors; and memory storing instructions that, when executed by the one or more processors, cause the electronic device to: obtain a configuration that defines a plurality of regions of interest, each having a polygonal boundary and one or more model-defined object classes of interest; preprocess the video frames to normalize one or more input characteristics; execute at least one object detection model to produce detections, each including a location and a class label; for each region of interest, determine an in-bound subset of detections based on class membership and spatial inclusion within the polygonal boundary; associate in-bound detections across successive frames to maintain track identities over a temporal window without storing raw video frames; generate separate region-specific inference outputs for the plurality of regions of interest; and emit a real-time inference signal to a downstream system based on at least one of the region-specific inference outputs.

In some aspects, the techniques described herein relate to a computer-implemented system for monitoring and analyzing congestion trends, including: one or more video input interfaces configured to receive video data from at least one of a live video stream, a camera-based video source, and a recorded video source; an edge device including at least one processor and at least one memory storing instructions that, when executed, cause the at least one processor to perform frame-level inference on the video data; a processing pipeline executed by the edge device, the processing pipeline including a preprocessing module and a normalization module configured to normalize each frame of the video data; an object detection module configured to detect objects of interest within each normalized frame using one or more machine learning models; a class and region filtering module configured to filter the detected objects based on object class and one or more defined regions of interest; a motion vector and feature association module configured to associate the detected objects across frames based on motion and feature data; a multi-frame tracking module configured to generate object tracks over multiple frames; a multi-frame inference data store configured to store structured inference results generated by the processing pipeline; and a data ingestion service communicatively coupled to the multi-frame inference data store and configured to receive the structured inference results, the data ingestion service including: an aggregation module configured to aggregate tracking and detection data across time and across the one or more defined regions of interest; an anomaly filtering module configured to detect and filter anomalous data segments; and a reporting and prediction module configured to generate congestion-related metrics and predictive outputs; and one or more real-time content consumer systems configured to receive real-time inference outputs from the edge device.

In some aspects, the techniques described herein relate to a computer-implemented method for congestion monitoring, including: receiving video data from at least one video source; performing, at an edge device, preprocessing and normalization on frames of the video data; detecting objects of interest in the frames using one or more machine learning models; filtering the detected objects based on object class and one or more regions of interest; associating the detected objects across frames using motion and feature data; generating multi-frame object tracks; storing structured inference results in a memory; transmitting the structured inference results to a data ingestion service; aggregating the structured inference results to generate congestion metrics; filtering anomalous data segments; and providing congestion-related outputs to one or more downstream systems.

In some aspects, the techniques described herein relate to an edge processing device for video analytics, including: an image capture module configured to generate video frames; at least one processor; at least one memory storing instructions that, when executed by the at least one processor, cause the at least one processor to perform preprocessing, object detection, region filtering, feature association, and multi-frame tracking; and a communication interface configured to transmit structured inference artifacts to a remote data ingestion service.

### DETAILED DESCRIPTION

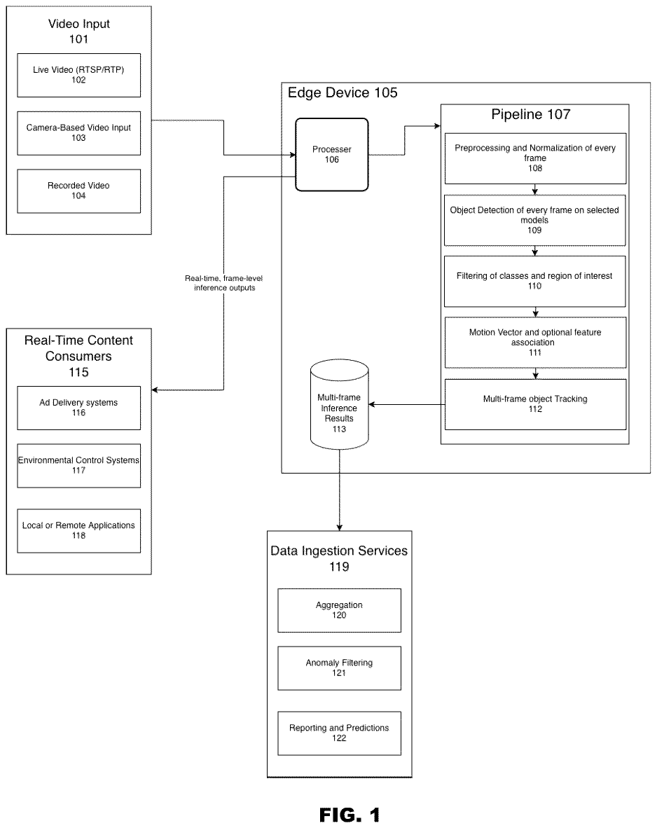

FIGS. 1-8 illustrate example automated methods and systems for analyzing visual data captured within physical environments and for generating real-time inference signals for decision-driven applications, including object presence and count estimation. In some embodiments, the disclosed system employs configurable object detection, classification, and tracking techniques in combination with one or more adjustable masking configurations to isolate regions of interest and mitigate location-specific biases. Processing may be performed primarily on an edge-enabled visual sensing device to reduce latency, preserve privacy, and enable real-time responsiveness, while selected inference outputs may be transmitted to downstream systems for aggregation, reporting, or predictive analysis. The architecture is modular and extensible, supporting a wide range of use cases including congestion analysis, class-based targeting, and real-time content selection, while preventing the storage of personally identifiable information.

FIG. 1 is a diagram illustrating an example architecture for analyzing visual data and generating inference outputs within a physical environment. The architecture receives video input from one or more video sources 101, including but not limited to live video streams 102, camera-based video input 103, or recorded video 104, and routes the video data to an edge-enabled device 105 for local processing. The edge-enabled device executes a structured processing pipeline 107 comprising multiple sequential stages that operate on individual video frames to identify what objects are present within a frame, classify such objects into one or more predefined categories, and filter detections based on regions of interest or application-specific criteria. The pipeline further supports associating detections across successive frames to enable basic tracking, primarily for stabilizing detections and deriving accurate object counts over time. The architecture is configured to produce real-time, frame-level inference outputs representing the presence and quantity of objects such as pedestrians or vehicles, while supporting modular downstream processing and preserving privacy by minimizing the transmission or storage of raw video data.

The video data undergoes preprocessing directly on the edge-enabled device 105 as an initial stage of the processing pipeline 107. This preprocessing stage 108 is configured to normalize incoming video input to account for variations in frame rate, resolution, encoding format, and camera characteristics across different video sources. By producing a standardized frame representation, the preprocessing stage ensures consistent and reliable operation of subsequent stages in the pipeline regardless of the source or format of the video input.

Following preprocessing, each normalized video frame is processed by an object detection stage 109 executed on the edge-enabled device 105 as part of the processing pipeline 107. The object detection stage 109 applies one or more object detection models to identify and localize objects present within each frame, such as pedestrians, vehicles, or other application-relevant entities. The object detection models may include pre-trained models, customized models trained for a specific deployment environment, or combinations thereof, allowing the system to adapt to different use cases, object classes, and environmental conditions. For each processed frame, the object detection stage 109 generates inference outputs describing the presence, classification, and spatial location of detected objects, which are forwarded to subsequent stages of the processing pipeline for further analysis.

Following object detection 109, the processing pipeline 107 performs a filtering stage 110 on the edge-enabled device 105 to selectively retain detected objects based on both object class and spatial relevance. In this stage, detected objects are first filtered according to one or more model-defined object classes associated with a given use case, such as pedestrians, vehicles, bicycles, or other configurable classes of interest. The remaining detections are then evaluated relative to one or more configurable regions of interest defined within the video frame. These regions of interest specify spatial boundaries corresponding to application-relevant areas, such as sidewalks, roadways, storefront zones, or other environment-specific locations. Objects that do not match the configured class criteria or fall outside the defined regions of interest may be excluded from further processing. By combining class-based filtering with spatial filtering, this stage reduces noise, mitigates location-based bias, and ensures that subsequent pipeline stages operate only on detections that are relevant to the intended analytical or real-time inference objectives. In some embodiments, multiple regions of interest or multiple object classes are evaluated concurrently, enabling parallel counting or analysis and the generation of separate, disjoint inference outputs for each configured region or class.

Following filtering stage 110, the processing pipeline 107 performs a motion analysis stage 111 on the edge-enabled device 105 to derive movement-related information for each retained detected object. In this stage, the system computes one or more motion vectors representing changes in position of detected objects across successive video frames, including magnitude and direction of movement. In some embodiments, the motion analysis stage may further incorporate optional feature-based association, wherein visual or learned feature representations extracted from detected objects are used to improve correspondence of objects across frames, particularly in environments with occlusion, high density, or rapid motion. The resulting motion vectors and associated metadata enable downstream determination of object trajectories, flow direction, and count stability, while maintaining a frame-level, privacy-preserving representation that does not require retention of raw video data.

Based on the motion information produced in stage 111, the processing pipeline 107 performs a multi-frame object tracking stage 112 on the edge-enabled device 105. In this stage, detected objects are associated across successive video frames to maintain object identity over time and to form continuous object tracks. The tracking stage leverages motion vectors, temporal consistency, and, where available, optional feature associations to determine whether detections in adjacent frames correspond to the same physical object. By maintaining persistent object identities across frames, the tracking stage enables reliable estimation of object trajectories, dwell time, directionality, and entry or exit events within the environment. The multi-frame tracking outputs are represented as lightweight metadata structures and are generated without requiring storage of raw video frames, thereby supporting real-time operation and preserving privacy while improving the accuracy and stability of object counts and movement analysis.

Following the multi-frame object tracking stage 112, the processing pipeline 107 stores the resulting inference outputs in a multi-frame inference results data store 113 resident on, or accessible to, the edge-enabled device 105. This data store is configured to persist structured inference results generated across one or more frames, including object identifiers, class labels, motion vectors, trajectory information, timestamps, and associated metadata. The stored inference results represent a lightweight, non-visual representation of observed activity within the environment and may be organized as a sequence of frame-level or windowed inference records. By persisting inference outputs independently of raw video data, the system enables downstream aggregation, analysis, auditing, or replay of inference results without retaining personally identifiable visual information, while also supporting fault tolerance, delayed processing, and interoperability with subsequent analytical or real-time consumption stages.

The architecture supports an aggregation and analytics stage that operates on stored multi-frame inference results 113 over extended temporal windows. In some embodiments, the multi-frame inference results 113 generated on the edge-enabled device 105 are synchronized to one or more remote data ingestion services 119 for downstream processing, durability, or cross-device analysis. An aggregation stage 120 operates on the synchronized inference results to compute higher-level metrics such as object counts, flow rates, dwell time, directional movement patterns, or class-based distributions across frames, time intervals, or deployment locations. The aggregation stage further incorporates an anomaly filtering stage 121 configured to identify, suppress, or normalize anomalous inference outputs resulting from transient environmental changes, sensor interruptions, occlusions, or atypical activity patterns.

Following aggregation and anomaly filtering, the architecture includes a reporting and prediction stage 122 configured to operate on the aggregated inference outputs generated by stages 120 and 121. The aggregated and filtered results are used to generate configurable reports, summaries, or analytics outputs tailored to specific use cases, stakeholders, or operational requirements, and may be consumed by local or remote applications for monitoring, auditing, optimization, or retrospective analysis. In this stage, the system produces configurable reports, dashboards, summaries, or data exports that reflect observed movement patterns, object counts, class-based distributions, or temporal trends over defined time intervals or deployment locations. In some embodiments, the reporting and prediction stage 122 further applies predictive or forward-looking analysis techniques to estimate future activity patterns, demand levels, or environmental conditions based on historical inference data. Such predictions may include anticipated changes in object volume, flow direction, or class composition, and may be generated using statistical models, learned models, or rule-based logic. The reporting and prediction outputs may be consumed by local or remote applications for planning, optimization, forecasting, or strategic decision-making, and operate independently of the real-time inference signals used for immediate control or response.

In parallel with storing multi-frame inference results, the processor 106 is further configured to emit real-time inference signals derived from individual video frames or short temporal windows to one or more real-time consumers 115. These real-time inference signals represent instantaneous detection and classification outputs, such as object presence, object counts, object class distributions, or movement indicators, without requiring multi-frame aggregation or historical context. The real-time inference signals may be generated at frame-level granularity or at configurable sampling intervals and are designed to be consumed immediately by downstream systems requiring low-latency responses. Such downstream consumers may include ad delivery systems 116, environmental control systems 117, and other local or remote applications, including content playback systems, control systems, or real-time decision engines executing on the same edge-enabled device 105 or on an external system. By decoupling real-time inference emission from multi-frame aggregation and storage, the architecture enables immediate response to current environmental conditions while preserving the ability to perform more computationally intensive analysis asynchronously.

Privacy and anonymization are central to the system's design, with all sensitive data handled exclusively during preprocessing and deleted afterward, ensuring no personally identifiable information is stored or retrievable. The architecture's modular design allows for extensibility, supporting applications such as congestion analysis, pedestrian monitoring, luxury and demographic studies. By enabling the integration of new detection models and functionalities, it can be adapted to diverse scenarios, such as pet tracking or gaze analysis.

The architecture's modular design enables extensibility across a wide range of applications, including congestion analysis, pedestrian monitoring, class-based audience analysis, pet-friendly area assessment, and generalized demographic or object count analytics.

The system supports both real-time and non-real-time video streams, making it suitable for immediate traffic management as well as retrospective analysis of congestion trends. With its multi-stage detection architecture, edge processing capabilities, and focus on privacy, this framework is an adaptable and efficient solution for urban congestion monitoring. It offers scalable insights for smart city initiatives while adhering to strict privacy protocols and leveraging advanced technologies for focused and secure data analysis.

The system includes one or more edge-enabled visual sensing devices equipped with image sensors configured to process video data locally at or near the location where the video is captured, rather than transmitting raw video streams to a remote server or cloud-based processing environment. Each edge-enabled device integrates onboard computational resources capable of executing the processing pipeline in real time, including tasks such as video normalization, object detection, filtering, motion analysis, and multi-frame inference generation. By performing the majority of visual analysis on the device itself, the system reduces end-to-end latency, minimizes network bandwidth utilization, and limits dependence on external infrastructure, while enhancing privacy and security by restricting the transmission of raw visual data.

In some embodiments, the image sensors implemented by the edge-enabled devices comprise CMOS (Complementary Metal-Oxide-Semiconductor) sensors optimized for real-time video capture and analytical workloads. These sensors are configured to operate reliably under a range of environmental conditions, including varying illumination levels, lighting transitions, and crowded or high-motion scenes. Features such as high frame-rate capture, wide range, and noise reduction may be employed to improve image quality and detection stability, particularly in low-light or fast-changing environments. The sensors may further be selected for compact form factor and low power consumption to support continuous operation in long-duration or resource-constrained deployments.

To support edge-based processing, the image sensors are coupled with onboard processing units configured to perform initial image processing, inference execution, and metadata generation directly on the device. This local processing architecture enables near-immediate generation of inference outputs, such as object presence and counts, without requiring centralized video processing. By limiting external data transmission to structured inference results or aggregated metadata, the system enhances privacy protections and supports scalable deployment while enabling downstream aggregation, reporting, or predictive analysis without reliance on raw video retention.

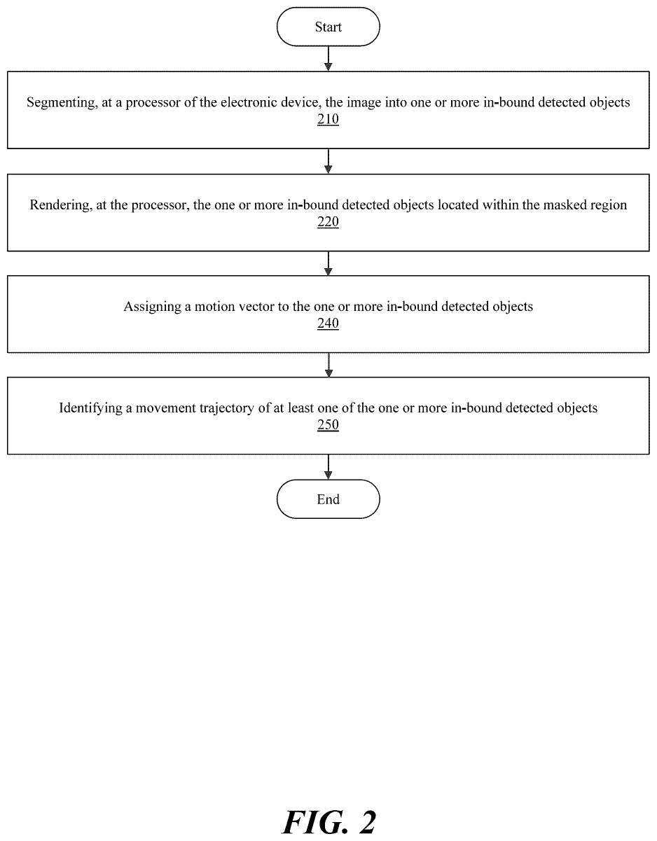

FIG. 2 is a flowchart illustrating a method according to some embodiments of the present disclosure. At step 210, the method may include segmenting an image, using a processor of the electronic device, into in-bound detected objects within a masked region based on spatial boundaries of the masked region defined by a masking configuration defined at every edge device. At step 220, the method may involve rendering the in-bound detected objects located within the masked region. Step 240 involves assigning motion vectors to the in-bound. At step 250, the processor may identify the movement trajectory of at least one of the in-bound detected objects based on one or more factors, including the captured image from an image sensor of the electronic device, and the magnitude and direction of the motion vector for each detected object, as implemented by the tracking algorithm.

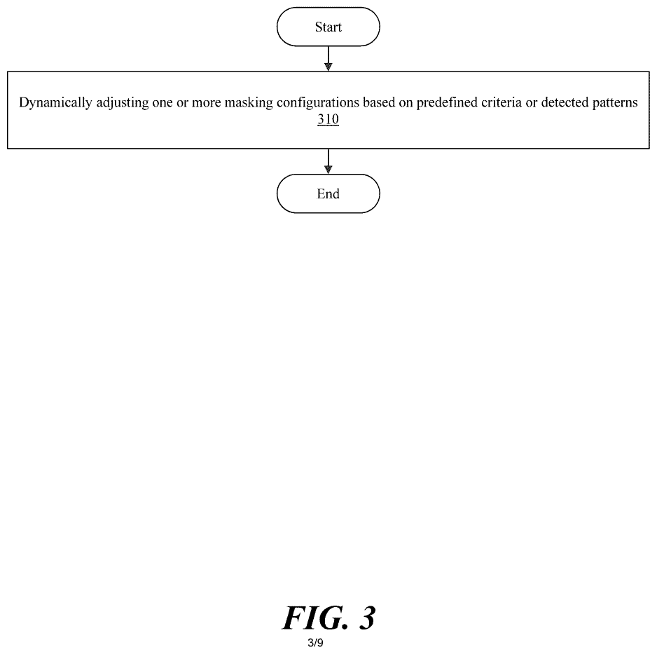

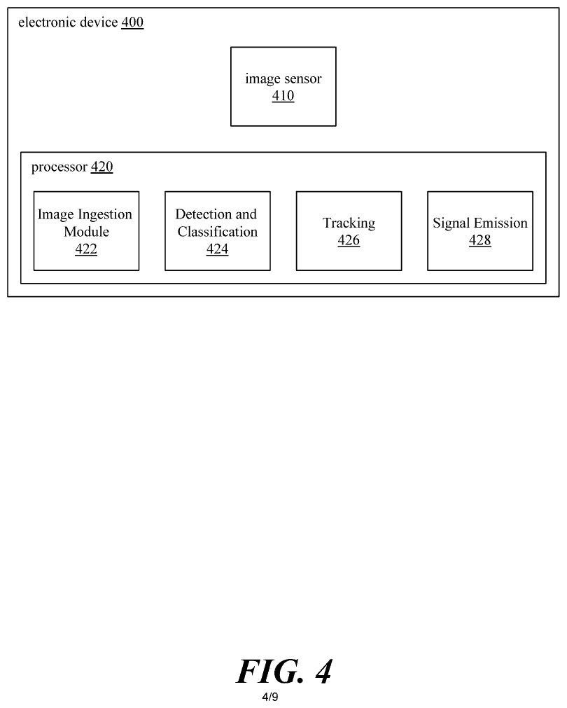

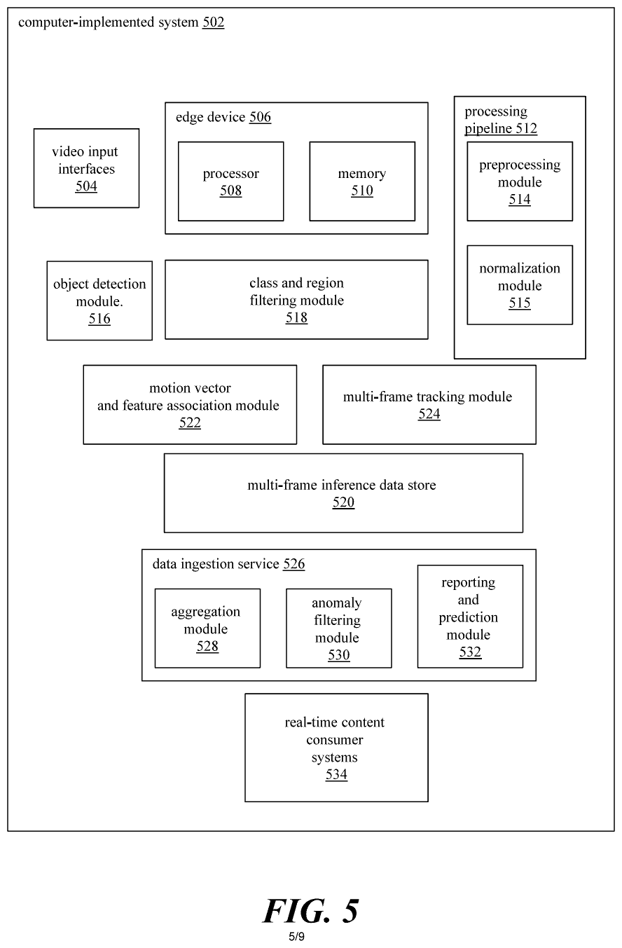

FIG. 3 is a flowchart describing the method according to some embodiments. In step 310, the method may involve adjusting one or more masking configurations based on predefined criteria or detected patterns. In some embodiments, an aggregation processor may analyze historical data trends to predict future congestion patterns.

In certain embodiments, the electronic device may be an edge processing camera.

FIG. 4 is a block diagram of an electronic device 400 according to some embodiments. The electronic device 400 may include an image sensor 410 that captures object data from an image of the device's environment, providing position information for detected objects. The processor 420 may include functionality for processing the image, such as capturing images 422 from the image sensor 410, segmenting the image into in-bound and out-bound detected objects 424, and assigning motion vectors to the detected objects, such as magnitude 426 and direction 428. The processor 420 may also render the in-bound and out-bound detected objects, adjust masking configurations, and identify movement trajectories of detected objects based on motion vectors, all implemented by a tracking algorithm. Additionally, the processor may include capabilities for analyzing historical data trends to predict future congestion patterns. In some embodiments, the electronic device may be an edge processing camera.

FIG. 5 illustrates a computer-implemented system 502 configured for monitoring and analyzing congestion trends using video-derived analytics. The system 502 includes one or more video input interfaces 504 that receive video data from heterogeneous sources, including live video streams transmitted using network protocols, camera-based video inputs from directly connected imaging sensors, and recorded video files retrieved from storage systems. The video input interfaces 504 may include decoding circuitry, timestamp alignment logic, frame buffering, and format conversion components that convert incoming streams into a standardized frame sequence for downstream processing. By normalizing the temporal and structural characteristics of incoming video, the system ensures consistent operation across varying camera vendors, resolutions, and frame rates.

Video frames from the video input interfaces 504 are provided to an edge device 506 that performs distributed inference close to the point of capture. The edge device 506 includes at least one processor 508 and at least one memory 510 storing executable instructions and intermediate data structures. The processor 508 may include general-purpose cores and hardware accelerators such as graphics processing units or neural processing units configured for machine learning inference. Performing inference at the edge device 506 reduces the need to transmit high-bandwidth video streams to centralized infrastructure, thereby lowering network utilization and enabling low-latency analytics. The edge device 506 executes a processing pipeline 512 comprising a preprocessing module 514 and a normalization module 515. The preprocessing module 514 may apply image conditioning operations such as resizing, de-noising, contrast equalization, or color space transformation. The normalization module 515 standardizes frame dimensions, aspect ratios, and pixel intensity distributions so that subsequent inference models receive uniform inputs. These steps improve numerical stability and model performance under varying environmental conditions, including lighting changes, weather variability, and motion blur.

Preprocessed and normalized frames are supplied to an object detection module 516 configured to identify objects of interest within each frame. The object detection module 516 may employ one or more trained machine learning models that output bounding regions, object class identifiers, and confidence values. Detected objects are forwarded to a class and region filtering module 518. The class and region filtering module 518 filters detections based on object class and spatial relevance using defined regions of interest. Regions of interest may be represented as geometric masks corresponding to sidewalks, traffic lanes, entryways, or other zones relevant to congestion analysis. By filtering detections to those within selected regions, the system reduces extraneous processing and focuses computational resources on contextually significant areas.

Filtered detections are provided to a motion vector and feature association module 522. This module extracts motion descriptors, such as displacement vectors and velocity estimates, and appearance-based features from detected objects. Using these features, the module associates detections across consecutive frames to maintain object continuity. The association process reduces identity switching and improves tracking persistence, which in turn reduces the number of active track states stored in memory and stabilizes the processing load.

Outputs of the association module 522 are provided to the multi-frame tracking module 524, which constructs and maintains persistent object tracks across successive video frames. The association module supplies candidate linkages between detections in adjacent frames based on spatial proximity, motion continuity, and feature similarity. The tracking module 524 uses these associations to update existing track states or initialize new tracks when previously unseen objects are detected. Each track maintained by the tracking module 524 is represented as a structured data record stored in memory. The record may include a temporal sequence of object positions expressed in image coordinates or mapped spatial coordinates, corresponding timestamps for each observation, motion parameters such as velocity vectors and directionality estimates, and confidence scores reflecting detection reliability and association stability. The tracking module may also store historical state information, including track age, persistence duration, and occlusion indicators. For example, when a pedestrian enters a defined sidewalk region, an initial detection in frame t results in the creation of a new track record. As subsequent frames t+1, t+2, and so forth provide detections with similar appearance features and consistent motion, the module updates the same track record by appending new positional and temporal entries. If the pedestrian temporarily passes behind an obstruction, the module may use motion prediction models to maintain the track state for a short duration, reducing fragmentation. When the pedestrian exits the region of interest, the track is finalized and its summary attributes, such as dwell time and path length, are computed.

In high-density scenarios, the module manages multiple concurrent tracks while resolving potential identity conflicts. Confidence scores are updated based on detection consistency and feature matching quality, allowing the system to discard unreliable tracks and conserve memory. By maintaining structured track states rather than independent frame detections, the system reduces redundant processing in downstream aggregation stages and improves temporal coherence of congestion metrics. The multi-frame tracking process thus transforms frame-level detections into continuous object trajectories, enabling accurate flow analysis, dwell estimation, and direction tracking while improving processor efficiency by limiting repeated reinitialization and correction operations.

The structured inference results generated by the tracking pipeline are stored in the multi-frame inference data store 520 as compact metadata records rather than raw image or video data. Each record may correspond to a detection event, a track update, or a completed track summary, and may include fields such as timestamp, region identifier, object class, track identifier, position coordinates, velocity vectors, dwell duration, and confidence metrics. These records are organized in a time-indexed and region-indexed schema that enables efficient retrieval and aggregation without requiring frame-level image reconstruction. For example, instead of storing a full-resolution video frame to determine how many pedestrians occupied a sidewalk at a given time, the system stores a metadata entry indicating that a particular track identifier was present in a defined region between two timestamps. If ten pedestrians pass through the region in one minute, the data store holds ten compact track segments rather than thousands of image frames. This transformation reduces storage volume by orders of magnitude and minimizes disk input/output operations, improving database throughput and lowering long-term storage costs.

Because the data store operates on structured fields, downstream queries can be executed using indexed lookups rather than image processing routines. A request for average dwell time in a storefront region, for instance, can be satisfied by aggregating stored dwell duration values directly, without reprocessing video. Similarly, flow rates between regions can be computed by querying track transitions between region identifiers. This improves query response time and enables real-time dashboard updates. The multi-frame inference data store 520 communicates with the data ingestion service 526 through event-driven or batch transfer mechanisms. As new metadata records are written, they are streamed or periodically transmitted to the ingestion service, which performs higher-level aggregation and anomaly analysis. This decoupled architecture allows the tracking pipeline to operate continuously while analytics processes run in parallel, improving system scalability and maintaining consistent performance even under high data volumes.

The data ingestion service 526 includes an aggregation module 528 configured to transform frame-level detection and tracking outputs into structured, time-indexed analytical datasets. The aggregation module operates on metadata records representing object detections and tracks, each record including at least a timestamp, region identifier, object classification, and track attributes such as position, velocity, and dwell duration. By operating on metadata rather than image frames, the aggregation module reduces computational overhead and supports high-throughput processing. Aggregation occurs along both temporal and spatial dimensions. Temporally, the module groups detection and tracking records into configurable time windows, such as one-second, one-minute, or custom intervals. Within each interval, the module computes summary statistics including object counts, average dwell times, entry and exit rates, and motion direction distributions. For example, if multiple pedestrians traverse a sidewalk region within a 60-second window, the module generates a single aggregated record representing total pedestrian flow, average speed, and occupancy trends for that interval.

Spatial aggregation is performed across the defined regions of interest, which may correspond to sidewalks, traffic lanes, intersections, or storefront zones. The module maintains independent aggregates for each region while also supporting cross-region comparisons. For instance, counts from adjacent sidewalk segments may be combined to produce corridor-level congestion metrics, while intersection-level aggregates may track directional traffic flows. The aggregation module may employ incremental update techniques, where summary statistics are updated as new records arrive rather than recomputing aggregates from scratch. This reduces processor usage and memory access operations, enabling real-time operation even with high data volumes. Additionally, aggregation reduces the size of stored datasets by replacing numerous frame-level records with compact summary entries, improving storage efficiency and query performance for downstream analytics.

By converting high-frequency tracking metadata into structured temporal and spatial summaries, the aggregation module enhances throughput, lowers memory and storage demands, and enables efficient large-scale congestion analysis. The anomaly filtering module 530 operates on structured time-series tracking metrics generated by the multi-frame tracking module and stored in the multi-frame inference data store. Rather than analyzing raw video, the module evaluates numerical and statistical features derived from detection and tracking outputs, including object counts per region, track persistence durations, motion vector distributions, frame-to-frame detection continuity, and region-specific density trends. By operating on metadata, the module performs anomaly detection with substantially lower computational overhead than image-based analysis.

For example, camera occlusion may occur when a person, vehicle, or object temporarily blocks the camera lens. This condition may produce a sudden drop in detected objects across all regions of interest or a uniform reduction in detection confidence values. The anomaly filtering module identifies such patterns by detecting abrupt discontinuities in object count time series or correlated drops across multiple regions. When such an event is detected, the corresponding time interval is flagged, and the affected tracking data is excluded from aggregated congestion metrics. This prevents the system from triggering unnecessary recalculations or model reinitialization procedures that would otherwise consume processor cycles. Signal interruption or network instability may cause gaps in frame delivery or irregular frame timestamps. These conditions are detectable as missing data intervals, irregular sampling rates, or unexpected zero-detection segments. The anomaly filtering module compares observed frame intervals against expected timing patterns and flags periods with inconsistent temporal spacing. By isolating these segments, the system avoids extrapolating erroneous trends or performing corrective tracking operations that would increase memory and CPU usage.

Environmental interference, such as glare, heavy rain, or sudden lighting changes, may cause temporary spikes in false detections or erratic motion vectors. The module analyzes statistical properties such as detection variance, motion direction entropy, and region-specific density deviations. If these metrics exceed learned or predefined thresholds, the module marks the interval as anomalous. Downstream aggregation modules then exclude or down-weight these segments, preventing contaminated data from affecting predictive models and reducing the need for later data cleansing operations. Because anomalous segments are filtered before aggregation and long-term storage, the system reduces the volume of invalid records stored in databases, improving storage efficiency and query performance. Additionally, by preventing tracking algorithms from attempting to reconcile corrupted data, the module reduces unnecessary track recovery operations, lowers processor load, and stabilizes real-time performance. This metadata-driven anomaly handling thus provides both improved data reliability and tangible technical benefits to processing efficiency and system resource management.

The reporting and prediction module 532 operates on aggregated, region-tagged tracking metadata produced by the aggregation module and stored in structured time-series form. Rather than processing raw video, the module uses numerical congestion indicators, including object counts per region, flow rates, dwell time distributions, directional movement histograms, and temporal density gradients. These structured inputs enable efficient computation of congestion metrics without re-running image-based inference, thereby reducing processor load and improving system responsiveness. For example, the module may compute real-time congestion density for each region of interest by dividing active track counts by region area and applying temporal smoothing over a rolling window. It may also derive flow rate metrics by measuring the number of objects crossing virtual boundaries per unit time. Trend analysis functions examine these metrics over longer intervals to identify recurring patterns, such as daily peak periods, directional flow asymmetries, or gradual increases in occupancy.

Predictive modeling components use historical aggregated data to forecast short-term congestion conditions. Time-series models or regression-based predictors may estimate future object counts based on recent trends, periodic patterns, and contextual factors, such as time of day. Because predictions rely on compact numerical features rather than image data, model evaluation requires fewer computational resources and supports rapid recalculation when new data arrives. The module can also generate anomaly-based alerts when predicted congestion levels exceed thresholds, allowing external systems to respond in near real time. By working entirely on structured metadata, the reporting and prediction module improves database query efficiency, minimizes storage overhead, and enables scalable analytics across large deployments. These operations enhance the functioning of the computer system by transforming high-volume tracking data into actionable, low-bandwidth analytical outputs while maintaining low latency and efficient resource utilization.

Real-time inference outputs from the edge device 506 and processed analytics from the data ingestion service 526 may be provided to one or more real-time content consumer systems 534. These systems may include traffic management platforms, environmental control systems, retail analytics dashboards, or other responsive applications. The architecture supports both real-time and batch processing modes, enabling immediate response to live congestion conditions as well as historical analysis over extended periods. Through distributed edge inference, region-based filtering, multi-frame tracking, metadata-centric storage, and modular aggregation services, the system 502 improves processor utilization, reduces memory and network overhead, stabilizes latency, and enables scalable deployment across numerous video sources and environments. These features collectively enhance the functioning of computer vision analytics systems used for congestion monitoring.

The disclosed system provides multiple technical improvements to computer vision processing, data pipeline efficiency, and distributed analytics architectures. A primary benefit is reduced computational load through staged and region-aware processing. By applying preprocessing, normalization, object detection, class and region filtering, and tracking in a structured pipeline, the system limits downstream processing to contextually relevant objects rather than full-frame data. Spatial masks defining regions of interest allow filtering to occur at the metadata level, which reduces unnecessary feature extraction, tracking operations, and memory allocations. This improves processor utilization and stabilizes frame processing times, particularly in high-density scenes.

The edge device architecture provides a technical advantage by performing inference locally rather than transmitting raw video to centralized servers. This reduces network bandwidth consumption, lowers transmission latency, and decreases the load on central processing resources. Early-stage filtering and feature extraction at the edge also reduce redundant decoding and inference operations at higher system tiers, improving overall system scalability. The modular pipeline design enhances memory and cache efficiency. Each module operates on structured metadata representations rather than raw image data, minimizing data transformation overhead and improving inter-process communication performance. The separation of detection, tracking, aggregation, and reporting functions allows selective activation of modules based on deployment needs, preventing unnecessary processor and memory usage.

The multi-frame tracking framework reduces track fragmentation and identity switching, which decreases the number of active tracking states maintained in memory. This limits memory growth and reduces corrective processing cycles, contributing to predictable runtime performance. The anomaly filtering module further improves data integrity by preventing corrupted or incomplete data segments from propagating through analytics processes, thereby reducing reprocessing and database overhead. Support for both real-time and batch processing enables workload balancing. Processing resources can be reallocated between live analytics and historical analysis tasks based on system load, improving hardware utilization and maintaining low latency for time-sensitive operations. Thus, these features improve processor efficiency, memory management, network utilization, storage performance, and system scalability. The disclosed architecture therefore provides concrete technical enhancements to the functioning of computer systems performing large-scale video analytics and congestion monitoring.

The present disclosure relates to systems and methods for automated monitoring and analysis of congestion trends using video-derived spatial analytics. In contrast to systems that rely on static geometric regions, the disclosed system employs configurable masking layers that define flexible, non-rigid regions of interest within a video frame. These regions of interest may conform to real-world spatial contours such as sidewalks, crosswalks, storefront boundaries, or street segments that do not align with rectangular or grid-based zones. The masking layers operate to exclude visually noisy or bias-inducing areas, including entrances located near the camera, reflective surfaces, or high-turnover zones that would otherwise inflate counts due to repeated entry and exit events. A single video stream may be logically segmented into multiple independent sub-regions, each associated with its own counting, tracking, and analytics processes, thereby enabling section-specific congestion metrics from a common camera feed. The masks may be updated over time to account for environmental or structural changes, allowing the system to measure contextual congestion patterns rather than raw object presence.

Privacy preservation is implemented at the architectural level. Video data is treated as a transient processing medium and is used only for the extraction of abstracted features, including object detections, bounding regions, motion trajectories, counts, and statistical attributes. The system does not store facial embeddings, biometric identifiers, or persistent individual identifiers. Once feature extraction and ingestion are completed, the corresponding source video is deleted. Output data is maintained in aggregated form, including density measures, flow rates, directionality, dwell time, and temporal trends, such that the resulting dataset is non-individualized and cannot be used to re-identify a person. The system thereby functions as a crowd and flow analytics platform rather than an identity-based surveillance system.

In some embodiments, video processing is performed at an edge device comprising a custom camera platform that includes embedded processing hardware and optimized inference pipelines. Object detection, tracking, and pre-aggregation operations are executed locally on the device, and the device outputs structured metadata artifacts rather than raw video streams. Such artifacts may include detection events, track identifiers, motion vectors, and count summaries. Transmission bandwidth is reduced by communicating only compressed metadata to downstream systems. Edge-based processing reduces end-to-end latency, supports near-real-time congestion assessment, enhances privacy by limiting external transmission of imagery, and enables operation in environments with limited network infrastructure.

The system is camera-agnostic and is configured to ingest both live video streams and previously recorded video sequences. An ingestion and normalization layer processes video sources having varying frame rates, resolutions, fields of view, and environmental conditions, including lighting and weather variability. Adaptive preprocessing and parameter tuning maintain analytic performance across heterogeneous inputs. The same underlying analytics pipeline supports real-time monitoring applications as well as batch processing for retrospective congestion studies and historical trend analysis.

A multi-stage detection architecture is employed in which multiple models are orchestrated in a layered pipeline. A primary detection stage identifies objects of interest, including persons, vehicles, animals, or carried items. One or more secondary inference stages derive additional attributes, which may include demographic estimations, pose-related cues, or gaze-direction proxies. A tracking stage associates detections across frames to form trajectories and to compute motion patterns, speeds, and dwell times. This layered design enables granular analytics beyond simple counts and allows selective activation or deactivation of inference stages depending on the deployment context and privacy requirements. Individual stages may be upgraded or replaced without redesign of the entire pipeline.

The system architecture is modular and extensible. Functional components, including detection, tracking, attribute inference, aggregation, and visualization, operate as discrete modules with defined interfaces. Additional detection classes, feature extractors, or analytics routines may be integrated without altering the overall system framework. Improved tracking algorithms, inference models, or processing frameworks can be incorporated as they become available, enabling scalability across sites, industries, and use cases while maintaining architectural continuity. Because the system abstracts video into structured presence and motion data, it supports a wide range of applications beyond pedestrian congestion. The same platform may be used for vehicle traffic analysis, pedestrian circulation studies, retail zone dwell analysis, object tracking, and aggregate demographic trend estimation. This cross-domain applicability results from the combination of flexible region segmentation, multi-stage detection, edge processing, and modular analytics, distinguishing the disclosed system from single-purpose counting solutions.

The system implements a multi-stage detection architecture utilizing one or more convolutional neural network-based object detection models configured for real-time inference. These models may follow an anchor-free detection framework that predicts object locations and classifications directly from feature maps, and are optimized for high-speed processing and reduced computational overhead. A first-stage detection model identifies objects of interest, including persons and other relevant entities, within incoming image frames. Subsequent inference stages operate on intermediate detection outputs and feature representations rather than on raw pixel data, thereby avoiding redundant full-frame processing and improving overall processor efficiency.

Prior to inference, input frames undergo standardized preprocessing operations, including grayscale transformation and padding normalization. Grayscale conversion reduces input data dimensionality, lowering the number of arithmetic operations required during convolutional processing while preserving structural features relevant to object detection. Padding normalization ensures consistent spatial dimensions and aspect ratio handling across heterogeneous video sources, stabilizing convolutional operations and reducing variance in model outputs caused by inconsistent input scaling. These preprocessing operations improve numerical stability of the inference pipeline, reduce error propagation, and enhance detection reliability under variable lighting, weather, and motion conditions.

Outputs from the primary detection stage are passed to additional specialized neural network models configured to derive higher-level attributes from detected object regions. Because these downstream models operate on cropped object regions or intermediate feature embeddings rather than entire frames, the system reduces redundant computation, improves cache locality, and lowers memory transfer demands between processing units and memory. The hierarchical model arrangement enables multiple inference operations to execute in parallel within a constrained hardware environment, thereby increasing analytic throughput per frame without exceeding processor or thermal limits.

By partitioning detection and inference into staged model components and reusing intermediate features across models, the system reduces the total floating-point operations per processed frame and improves real-time performance on edge processing hardware. This architecture improves the functioning of the computer system itself by enhancing inference efficiency, optimizing memory bandwidth usage, and enabling sustained low-latency processing under resource constraints. The attribute inference models are configured to output abstracted, non-identifying statistical attributes rather than persistent biometric identifiers. The system therefore transforms high-bandwidth image data into compact, structured metadata representations, reducing storage demands and improving database and transmission efficiency. Thus, the staged neural network architecture, preprocessing normalization, and feature-reuse framework constitute a technical improvement in computer vision processing systems by increasing throughput, reducing computational redundancy, and stabilizing model performance across heterogeneous inputs.

The system includes an object detection and tracking data pipeline implemented as a scalable, asynchronous processing architecture executed by one or more processors. Unlike synchronous frame-by-frame pipelines that require sequential processing of all detection, tracking, and analytics operations, the disclosed pipeline decouples detection, region filtering, tracking, and aggregation into independently schedulable processing stages connected through non-blocking message queues or buffer structures. This architecture enables parallel execution of computational tasks across processor cores and allows the system to maintain real-time throughput even under high object density conditions. By preventing bottlenecks caused by sequential dependencies, the pipeline improves processor utilization, reduces idle cycles, and lowers end-to-end latency for congestion metric generation.

Detected objects produced by the detection stage are not processed uniformly across the full image space. Instead, each detection event is evaluated against one or more defined regions of interest that are represented using a specialized data structure referred to as a mask. A mask is a computer-readable spatial data object that encodes a flexible geometric boundary associated with a semantic context, such as a storefront area, crosswalk, roadway segment, or intersection zone. Masks may be stored in memory as coordinate sets, polygonal boundaries, rasterized bitmaps, or vector representations, and are indexed and retrieved for each processed video stream. Because masks are applied at the metadata level to detected object coordinates rather than at the raw pixel level, the system avoids repeated full-frame image operations, thereby reducing computational overhead.

For each video input, multiple masks can be applied independently to the same stream of detection outputs. The pipeline associates detected object coordinates and track identifiers with each mask in parallel, enabling the system to generate multiple independent analytic outputs from a single detection pass. This design eliminates the need to re-run detection models for each region of interest, significantly reducing redundant inference operations and conserving processing cycles. As a result, the computer system can support multi-zone analytics with minimal incremental computational cost, improving scalability when monitoring complex environments containing many spatial subregions.

The asynchronous pipeline further enables adaptive filtering and tracking in environments with varying density and visibility. In high-density areas, the system can allocate additional processing resources to tracking stages associated with masks representing those zones, while deprioritizing low-activity regions. This resource allocation improves tracking persistence and accuracy in crowded scenes without increasing the overall system load. Additionally, by processing region-based analytics in parallel, the system reduces memory contention and improves cache locality, since each processing stage operates on compact detection metadata rather than full-frame image data.

The mask-based spatial abstraction also provides a technical data reduction function. Rather than storing or transmitting raw video frames, the system transforms image-derived detections into structured, region-tagged metadata records. These records contain object positions, trajectories, and temporal attributes associated with specific masks, thereby compressing high-bandwidth visual input into compact analytical representations. This transformation reduces storage requirements, decreases network transmission load, and improves database query performance for time-series congestion analysis. Through the combination of asynchronous processing, mask-based spatial data structures, parallel region evaluation, and metadata-level filtering, the disclosed pipeline improves the functioning of the computer system itself. It increases processing throughput, reduces redundant computations, optimizes memory usage, and enables real-time, multi-region analytics on edge or resource-constrained hardware.

The system includes an automated tracking parameter optimization framework executed by one or more processors to configure and maintain object tracking performance for each camera deployment. Rather than relying on fixed, globally defined tracking parameters, the system associates a parameter profile with each camera viewpoint, where the profile governs variables including detection confidence thresholds, intersection-over-union matching limits, track persistence timeouts, motion smoothing coefficients, and occlusion-handling parameters. These parameters are not manually hard-coded for ongoing operation but are computed through a hyperparameter optimization process that evaluates tracking performance against a ground-referenced dataset generated for that specific camera geometry.

For each new camera installation or change in viewpoint, the system performs an auditing phase in which representative video samples are processed and a reference count of relevant objects is established. A hyperparameter search routine then iteratively adjusts tracking parameters and evaluates resulting tracking outputs using objective performance metrics such as detection consistency, track continuity, and count accuracy. The optimization process may employ automated search strategies including grid search, Bayesian optimization, or gradient-free search techniques. This automated tuning reduces human intervention and enables the system to converge on a parameter set that is computationally efficient while maintaining tracking fidelity. As a result, the computer system operates with fewer identity switches, reduced track fragmentation, and lower false tracking persistence, thereby decreasing downstream correction overhead and improving overall processing efficiency.

The optimized parameter sets also improve the functioning of the computer system itself. By minimizing erroneous track creation and premature track termination, the system reduces the number of active track objects maintained in memory and lowers the frequency of reprocessing operations triggered by tracking errors. This reduces processor cycles spent on correction routines, improves cache efficiency, and stabilizes runtime performance in high-density scenes. The system therefore enhances real-time performance and resource utilization through adaptive algorithm configuration rather than through increased hardware capacity.

Once operational trends are established, the system continuously applies anomaly detection to tracking output metrics to identify deviations indicative of system-level disturbances. These disturbances may include power interruptions, network outages, temporary camera obstruction, or environmental conditions that degrade image quality. The anomaly detection component analyzes time-series features derived from tracking outputs, including sudden count discontinuities, abnormal motion vector distributions, or unexpected drops in track persistence. When anomalies are detected, associated data segments are flagged or excluded from aggregated datasets. This automated data-quality control mechanism prevents corrupted or incomplete tracking outputs from propagating through analytics pipelines, thereby improving the reliability of stored data and reducing the need for manual post-processing.

The use of multiple masks associated with a single camera vantage point provides additional internal consistency checks. Because each mask represents an independent spatial subregion, the system can compare trends across masks to detect inconsistencies that may signal localized occlusion or processing errors. Cross-mask correlation thus functions as a built-in redundancy mechanism that enhances fault detection without requiring duplicate hardware sensors. This improves data integrity while minimizing additional computational overhead.

Through automated hyperparameter optimization, anomaly detection, and mask-based redundancy, the system adapts tracking algorithms to real-world deployment conditions in a manner that improves the operation of the underlying computer system. For example, hyperparameter optimization reduces processor load by minimizing unnecessary tracking computations. When tracking parameters, such as object association thresholds or track persistence durations, are not tuned to the camera geometry, the tracker may generate excessive false tracks or repeatedly reinitialize tracks for the same object. Each false or fragmented track requires memory allocation, state updates, and motion estimation calculations. By selecting optimized parameters that reduce identity switches and track fragmentation, the system decreases the number of active track objects stored in memory and reduces the frequency of corrective processing. This leads to lower CPU utilization, fewer cache misses, and more stable frame processing times.

The optimization process also improves memory efficiency by preventing uncontrolled growth of tracking state tables. In high-density scenes, poorly tuned tracking parameters can cause a proliferation of short-lived track records. Each record consumes memory for storing positional history, motion vectors, timestamps, and confidence values. By converging on parameter sets that maintain track continuity only where appropriate, the system limits the number of concurrent track structures, thereby reducing memory fragmentation and improving cache locality. This contributes to predictable memory usage patterns that support sustained real-time performance on edge hardware with constrained memory resources.

Anomaly detection further enhances system-level performance by identifying data segments that would otherwise degrade downstream processing. For instance, a sudden drop to zero detections during a power interruption or camera obstruction can cause tracking algorithms to enter recovery modes that repeatedly search for lost tracks, increasing computational overhead. By detecting such anomalies at the metadata level and flagging the affected intervals, the system prevents unnecessary reprocessing and avoids skewing trend calculations. Similarly, detection of abnormal motion distributions caused by severe weather or lighting glare allows the system to suspend or adjust tracking operations temporarily, preventing wasted processor cycles on low-quality inputs.

Mask-based redundancy provides an additional mechanism for maintaining computational stability. When multiple masks are defined for different subregions within the same field of view, the system can compare object counts and motion statistics across these regions. If one mask shows abnormal behavior, such as an unexpected surge in detections due to glare or reflection, while adjacent masks remain stable, the system can isolate the anomaly to a specific region rather than triggering global recalibration. This localized handling reduces the need for full-pipeline resets or model reinitialization, thereby maintaining continuous operation and reducing latency spikes.

These adaptive mechanisms collectively stabilize real-time processing performance. Frame processing time remains within a narrow variance range because the number of active tracking entities and corrective operations is controlled. Processor scheduling becomes more predictable, enabling consistent throughput even under changing environmental conditions. Furthermore, by filtering anomalous or corrupted data before storage, the system reduces the volume of invalid records, improving database efficiency and query performance for historical trend analysis. Accordingly, the disclosed techniques provide technical improvements in processor utilization, memory management, data integrity, and real-time scheduling within computer vision tracking systems. These improvements address technological challenges inherent in processing high-variability video streams and enable accurate, low-latency congestion analytics across diverse camera geometries and environmental conditions. The system includes a custom edge-processing camera configured as an integrated vision sensor and embedded computing platform. The device incorporates an image capture module, on-device memory, and a dedicated processing unit, such as an embedded GPU, neural processing unit, or system-on-chip accelerator, configured to execute computer vision inference models locally. Unlike conventional camera systems that stream raw video to remote servers for processing, the disclosed device performs object detection, tracking, feature extraction, and attribute inference directly on the device prior to transmission. The camera thus operates as an intelligent sensing node that outputs structured analytical artifacts rather than high-bandwidth video streams.

The edge device executes detection and inference models in real time and generates intermediate data artifacts, including bounding regions, object classifications, track identifiers, motion vectors, and abstracted attribute indicators. These artifacts are serialized into compact metadata records and transmitted to the downstream tracking and analytics pipeline. Because only structured metadata is transmitted, the system reduces network bandwidth consumption, lowers transmission latency, and decreases dependence on continuous high-throughput connectivity. This architecture enables sustained operation in environments with constrained or intermittent network access while maintaining real-time analytics performance.

Local inference also improves processor and system efficiency at the overall architecture level. By performing early-stage filtering and feature extraction on the device, the system avoids redundant decoding, scaling, and inference operations that would otherwise occur on centralized servers. The reduction in raw data transmission decreases network I/O bottlenecks and reduces the load on centralized compute infrastructure. Downstream processors receive pre-filtered, structured inputs, allowing them to allocate computational resources to higher-level analytics rather than low-level image processing. This distributed workload model improves system scalability and allows additional camera nodes to be deployed without linearly increasing central processing requirements.

The device further incorporates transient buffering mechanisms, in which raw frames are retained only in volatile memory for the duration required to perform inference and optional auditing functions. After feature extraction, the raw image data is automatically discarded and not written to persistent storage. This design reduces long-term storage demands, lowers disk I/O overhead, and improves database performance because only compact analytical records are stored. By eliminating persistent storage of raw video and facial imagery, the system reduces data retention overhead and simplifies memory management, which improves overall system responsiveness and reduces storage subsystem load.

Synchronization between the edge device and the central tracking pipeline may be implemented using event-driven messaging, in which the edge camera publishes structured detection events as soon as they are generated. For example, upon detecting a person entering a defined region of interest, the edge device may generate a metadata packet containing a timestamp, region identifier, bounding box coordinates, object classification, and a temporary track identifier. This packet is transmitted via a lightweight message protocol to a central message broker, where a subscriber service updates the global tracking state. Because only the structured metadata is transmitted, the central system does not decode or analyze the original video frame, thereby avoiding redundant convolution and image preprocessing operations.

In another example, the edge device may accumulate tracking updates for short intervals, such as one-second windows, and transmit batched metadata records. Each batch may contain trajectory segments, velocity vectors, dwell-time counters, and region tags for multiple tracked objects. The central system ingests the batch and appends the data to existing track histories, enabling long-term movement analysis without re-running detection or tracking algorithms. This reduces network overhead and improves throughput because multiple inference results are transmitted in a single payload rather than as individual frame-level messages.

In environments with intermittent connectivity, the edge device may maintain a rolling buffer of metadata in local memory. When connectivity is restored, the buffered metadata is transmitted in time-ordered batches. The central pipeline replays these events to reconstruct object trajectories and congestion metrics for the missing interval. Because the data consists of structured tracking artifacts rather than raw video, synchronization can occur quickly with minimal bandwidth, and the central processors avoid costly reprocessing of stored video.

Another example involves event-triggered synchronization. If the edge device detects a threshold condition, such as a congestion level exceeding a predefined value, it may immediately transmit a high-priority event containing aggregated counts, density metrics, and region identifiers. The central system can use this event to update dashboards or trigger alerts without requesting video frames. This event-based integration minimizes latency and reduces processing load at the central server.

These synchronization approaches allow the central tracking pipeline to treat the edge device as a distributed inference node that supplies ready-to-use analytical artifacts. By eliminating the need to reprocess imagery centrally, the system reduces CPU and GPU utilization, lowers memory bandwidth consumption, and improves overall scalability of the computer system as additional edge devices are deployed. This avoids duplicated computation across system tiers and ensures that tracking continuity is maintained with minimal latency. The result is a pipeline in which high-cost image processing tasks are offloaded to distributed edge hardware while centralized components focus on aggregation, trend analysis, and anomaly detection. Through these mechanisms, the custom edge-processing camera provides technical improvements to computer vision processing systems, including reduced network bandwidth utilization, lower end-to-end latency, improved processor load balancing, reduced persistent storage requirements, and more efficient memory and database operations. The device transforms the role of the camera from a passive data source into an active computational node, thereby improving the functioning of the overall computer system and enabling real-time congestion analytics under resource-constrained and privacy-sensitive deployment conditions.

The system is configured to process both real-time video streams and non-real-time, pre-recorded video sequences using a unified but adaptively scheduled processing architecture. An ingestion layer executed by one or more processors identifies the source type and configures buffering, task scheduling, and resource allocation strategies accordingly. For real-time streams, the system employs low-latency frame buffering and event-driven processing in which frames are processed within bounded time windows to meet real-time constraints. Detection, tracking, and analytics tasks are scheduled using priority queues to ensure that inference and tracking operations complete within a defined frame budget, thereby preventing backlog accumulation and maintaining consistent frame rates.

For non-real-time video sequences, the system transitions into a batch processing mode in which frame ingestion is decoupled from wall-clock time. In this mode, frames may be processed at accelerated rates limited primarily by processor and memory availability rather than by real-time constraints. The system allocates parallel processing threads or distributed compute nodes to analyze different video segments concurrently. This mode improves throughput efficiency by maximizing hardware utilization during off-peak periods and enables long-duration historical datasets to be processed without affecting real-time monitoring performance.

The architecture includes a unified metadata schema and intermediate data representation shared between real-time and batch modes. Detected objects, tracking states, and region-based metrics are stored in a normalized structure that supports incremental updates in real time and bulk aggregation in batch mode. Because both operational modes produce consistent structured outputs, downstream analytics, storage, and visualization systems do not require separate processing pipelines. This reduces software complexity, minimizes redundant data transformation routines, and lowers processor overhead associated with maintaining parallel code paths.

The ability to switch between real-time and batch processing also improves computer system efficiency. During periods of low live activity, the system can reallocate processing capacity to historical analysis tasks, thereby increasing overall hardware utilization and reducing idle processor cycles. Conversely, when live traffic increases, batch jobs may be throttled or paused to prioritize latency-sensitive operations. This workload management improves scheduling efficiency and maintains predictable system performance under varying operational demands. Additionally, the system incorporates adaptive frame sampling and temporal aggregation techniques. In real-time mode, frames may be sampled at rates optimized to maintain latency constraints while preserving detection accuracy. In batch mode, temporal down-sampling or aggregation may be applied to reduce redundant processing of near-identical frames, lowering total computation requirements without degrading analytic quality. These techniques reduce floating-point operations per dataset and improve memory and cache efficiency.

Through unified processing pipelines, adaptive scheduling, shared data representations, and workload balancing between real-time and batch modes, the system improves processor utilization, reduces latency variance, and enhances throughput efficiency. These features constitute technical improvements to computer vision data processing systems, enabling scalable, low-latency analytics while efficiently managing computational resources across diverse video-processing scenarios.

The system is implemented using a modular, service-oriented processing architecture that enables scalable deployment across multiple camera nodes, processing units, and analytics functions. Functional components, including video ingestion, object detection, tracking, attribute inference, region filtering, aggregation, storage, and visualization, are implemented as discrete processing modules with defined data interfaces. These modules communicate using standardized metadata schemas and message-passing protocols, allowing each component to operate independently without requiring changes to other parts of the system. This modular structure allows detection models, tracking algorithms, and inference engines to be replaced, upgraded, or extended without interrupting overall system operation.

Scalability is achieved through horizontal distribution of workloads across processing nodes. Detection and inference tasks may be executed on edge devices, local servers, or cloud infrastructure, depending on deployment requirements. As additional video sources are added, the system distributes new workloads across available processing resources rather than increasing the load on a single processor. The metadata-centric architecture reduces data transfer requirements between modules, which allows more simultaneous video streams to be supported within fixed network and hardware constraints. This improves throughput and enables the system to maintain low latency even as the number of monitored locations increases.

The modular configuration also improves computer performance by isolating resource-intensive tasks. For example, attribute inference modules can be deployed only where required, preventing unnecessary computational overhead in applications that require only object counting or tracking. Similarly, specialized models for new object classes or behaviors can be loaded without restarting the entire pipeline. This selective activation reduces processor load and memory consumption by ensuring that only relevant modules execute for a given deployment scenario. Because each module operates on structured metadata rather than raw video, the system reduces redundant data transformation operations and improves cache efficiency. Intermediate results are stored in normalized data structures that are reused across modules, avoiding repeated parsing or conversion steps. This reduces CPU cycles spent on data preparation and improves inter-process communication efficiency.

The architecture further supports elastic scaling of storage and analytics subsystems. Time-series databases and aggregation services can be scaled independently from detection and tracking services. This separation of concerns prevents analytic workloads from degrading real-time performance and allows historical analysis to be performed without affecting live monitoring. Load balancing between modules ensures consistent response times under varying system loads. By enabling distributed processing, selective module activation, efficient metadata exchange, and independent scaling of subsystems, the modular and scalable architecture improves processor utilization, reduces memory and network overhead, and maintains predictable latency. These characteristics represent technical improvements to the functioning of computer vision analytics systems, addressing challenges in processing large volumes of heterogeneous video data across diverse operational contexts.

In some embodiments, the preprocessing and normalization module is further configured to compensate for environmental and camera-specific variability that would otherwise degrade inference performance. For example, a camera mounted outdoors may experience changing illumination due to cloud cover, shadows from moving objects, or nighttime lighting. The preprocessing module may apply adaptive histogram equalization or exposure normalization to stabilize contrast across frames. In another example, a camera installed at an angle may introduce perspective distortion; the module may apply geometric correction or region-specific scaling so that object proportions remain consistent for the detection model. In environments with motion blur, such as fast-moving vehicle scenes, temporal smoothing or deblurring filters may be applied prior to normalization to improve detection reliability.

In some embodiments, the object detection module operates with multiple models specialized for different object classes. A first convolutional neural network may be optimized for pedestrian detection, while a second model may target vehicles or bicycles. The system may select or combine models depending on the defined regions of interest. For instance, a sidewalk mask may activate the pedestrian model, whereas a roadway mask activates the vehicle model. Because the detection framework is anchor-free, it can efficiently detect small, distant objects in one frame and large, close objects in another without recalibrating anchor sets. This flexibility reduces the number of candidate evaluations and improves inference speed.

In some embodiments, the spatial masks representing regions of interest may be updated in response to environmental changes. For example, temporary construction may alter pedestrian pathways, prompting a user or automated process to redefine mask boundaries. In another scenario, seasonal events such as outdoor seating arrangements may extend a storefront's active region into the sidewalk; an updated mask allows the system to include that area in congestion analysis. The system may also support hierarchical masks, where a large mask defines an overall corridor and smaller masks define subzones within that corridor for more granular metrics.

In some embodiments, masks stored as geometric data structures may include attributes such as priority levels or semantic labels. When detections overlap multiple masks, the system may assign the detection to the highest-priority region or to multiple regions for comparative analysis. Because mask evaluation occurs on coordinate metadata rather than pixel arrays, a single detection can be evaluated against multiple masks with minimal processing overhead.

In some embodiments, the motion vector and feature association module incorporates predictive modeling to maintain track continuity during temporary occlusions. For example, if a pedestrian passes behind a parked vehicle and is not detected for several frames, the module may project the expected position based on previous motion vectors and maintain the track state. When the pedestrian reappears, similarity thresholds based on appearance features confirm the match. In another example, two vehicles traveling in opposite directions may cross paths at an intersection; distinct motion vectors and appearance embeddings help preserve correct identity assignment. The module may also adjust similarity thresholds adaptively in crowded scenes to prevent track merging, improving tracking accuracy and reducing corrective processing.

The disclosed system provides technical improvements to computer vision processing architectures, distributed inference systems, and large-scale video analytics pipelines by increasing processing efficiency and stabilizing computational performance. Standardized preprocessing and normalization, including frame resizing, grayscale transformation when appropriate, and padding normalization to maintain consistent aspect ratios, deliver uniform inputs to the object detection module. This reduces numerical instability in convolutional operations, decreases corrective reprocessing steps, and enables consistent frame processing times across heterogeneous video sources. The anchor-free convolutional detection framework eliminates reliance on predefined anchor boxes, thereby reducing the number of candidate regions evaluated per frame and lowering floating-point operation counts, which improves inference throughput. This framework also adapts more effectively to objects at varying scales and orientations, reducing false detections and the downstream tracking overhead associated with correcting them. Region-of-interest masking further reduces computational load by filtering detections at the metadata level rather than the pixel level, ensuring that only objects within defined spatial masks proceed to feature extraction and tracking, which decreases processor utilization and memory consumption in scenes with high background activity. The motion vector and feature association module improves track continuity and reduces identity switching, avoiding frequent track creation and deletion and limiting growth of tracking state tables in memory. This leads to more predictable memory usage, improved cache locality, reduced redundant computation, enhanced processor utilization, and scalable, low-latency congestion analytics.

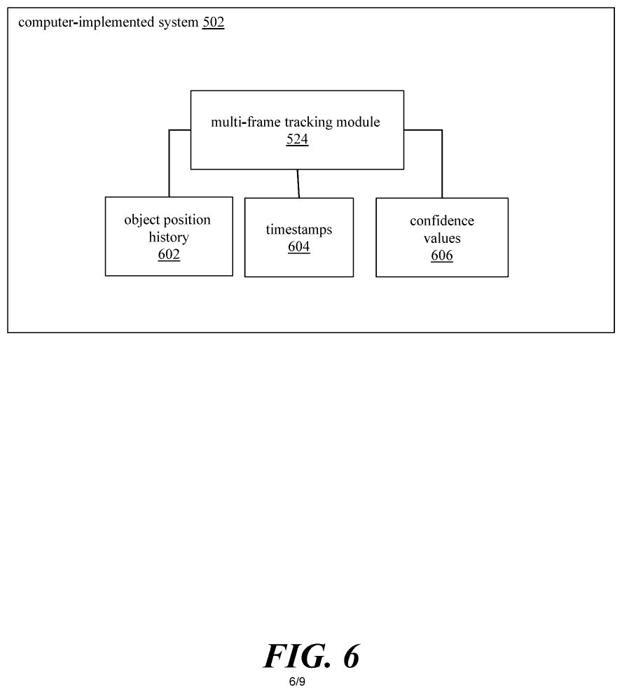

FIG. 6 illustrates an example implementation of track state information maintained by the multi-frame tracking module 524 within the computer-implemented system 502. In some embodiments, the multi-frame tracking module 524 maintains, in the at least one memory of the edge device or associated processing system, structured track state records corresponding to individual tracked objects. Each track state record may include an object position history 602. The object position history 602 may comprise a time-ordered sequence of spatial coordinates representing successive detected or estimated positions of an object across multiple frames. These coordinates may be expressed in image-space coordinates, such as pixel locations within a frame, or in transformed coordinates mapped to a reference plane corresponding to the monitored environment. As an object moves through a region of interest, the multi-frame tracking module 524 appends new position entries to the object position history 602, thereby forming a trajectory that reflects the path of movement over time. The track state record may further include timestamps 604 associated with each position entry or with groups of position entries. The timestamps 604 indicate the times at which the object was observed or at which position estimates were generated. Using the timestamps 604 in combination with the object position history 602, the multi-frame tracking module 524 can derive motion parameters such as speed, direction, and acceleration. For example, a pedestrian's dwell time within a storefront region can be computed by determining the interval between timestamps corresponding to entry into and exit from that region.

In some embodiments, the track state record also includes confidence values 606. The confidence values 606 may represent detection confidence scores obtained from the object detection module and association confidence metrics generated during frame-to-frame matching. These confidence values may be updated as additional frames are processed. For instance, if detections remain consistent in position and appearance over successive frames, the confidence value for the track may increase. Conversely, if associations become uncertain due to occlusion or ambiguous features, the confidence value may decrease. Tracks having confidence values below a threshold may be marked as tentative or terminated to conserve memory and processing resources. By maintaining the object position history 602, timestamps 604, and confidence values 606 in structured form within memory, the multi-frame tracking module 524 supports efficient updating of track states and enables downstream aggregation, dwell time analysis, and congestion metrics computation without requiring access to raw image data.

In some embodiments, the edge device is configured to transmit structured metadata representing detection and tracking artifacts to the data ingestion service without transmitting corresponding raw video frames. The structured metadata may include, for each detected or tracked object, a track identifier, object class label, bounding region coordinates, region-of-interest identifier, motion vectors, timestamps, and confidence values. For example, when a pedestrian enters a defined sidewalk region, the edge device may generate a metadata event indicating the track identifier, entry time, initial position, and associated region mask. As the pedestrian continues to move, subsequent metadata updates may include updated positions and velocity vectors. These metadata records are serialized and transmitted over a network interface to the data ingestion service, while the original video frames remain local to the edge device and may be discarded after processing. This approach reduces bandwidth usage and network latency because compact numerical records are transmitted instead of high-resolution imagery, and it reduces storage overhead at centralized systems.

In some embodiments, the anomaly filtering module is configured to identify data segments associated with camera obstruction, communication outage, or abnormal detection distributions. The module operates on time-series tracking and detection metrics rather than image data. For instance, if a camera lens becomes temporarily obstructed, the module may detect a sudden, simultaneous drop in object counts across all regions of interest, accompanied by reduced detection confidence values. This time interval may be flagged as anomalous and excluded from aggregated congestion metrics. In the case of a communication outage or frame delivery interruption, the module may detect irregular timestamp intervals or missing data segments, preventing the system from interpolating inaccurate movement or density values. Abnormal detection distributions may occur due to environmental factors such as glare, heavy rain, or lighting changes, which may produce sudden spikes in false detections or erratic motion vectors. Statistical thresholds applied to detection variance, motion direction entropy, or region-specific density trends enable the module to identify and filter such segments, improving the reliability of stored analytics.

In some embodiments, the reporting and prediction module generates congestion-related metrics and predictive outputs based on aggregated metadata. Congestion density metrics may be computed by dividing the number of active tracks within a region of interest by the area of that region, with temporal smoothing applied over rolling windows. Flow direction metrics may be derived by analyzing aggregated motion vectors to determine dominant movement directions through intersections or corridors. Dwell time statistics may be generated by calculating the duration each track remains within a region, such as the time pedestrians spend in front of a storefront. Trend forecasts may be produced using historical aggregated data, where time-series models estimate future congestion levels based on recent trends and periodic patterns. For example, the system may predict increased pedestrian density during recurring peak hours and provide early alerts to connected systems. Because these operations rely on structured metadata rather than raw imagery, the module performs analytics efficiently and supports rapid updates as new data arrives.

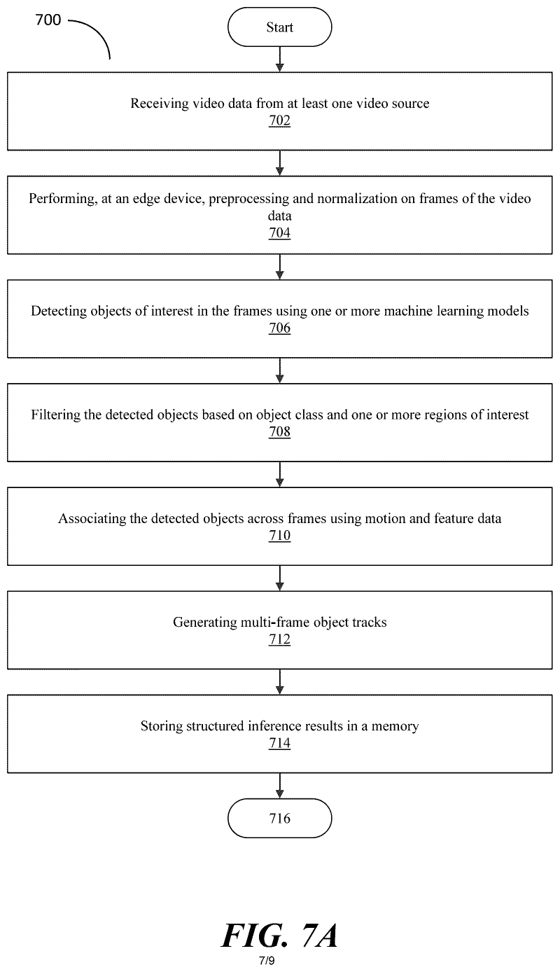

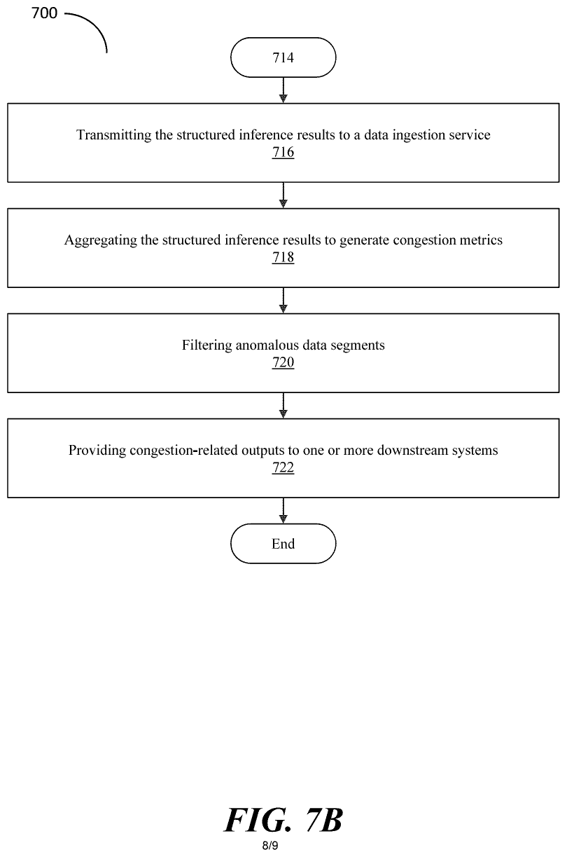

FIGS. 7A and 7B illustrate an example computer-implemented method 700 for congestion monitoring. The method 700 may be executed by one or more processors associated with an edge device and one or more downstream processing systems. At step 702, video data is received from at least one video source. The video source may include a live network video stream delivered using streaming protocols, a directly connected imaging device such as an IP camera or USB camera, or recorded video retrieved from local or remote storage, including files, databases, or archival systems. In some embodiments, the system may receive video from a single camera or from a plurality of cameras, such as 2-50 cameras at a single site, 50-500 cameras within a facility, or 500-5,000 cameras across distributed locations. The video streams may have resolutions ranging from 320×240 pixels to 7680×4320 pixels, with common operational ranges including 640×480 to 1920×1080 pixels and higher-definition inputs of 1920×1080 to 3840×2160 pixels. Frame rates may range from 1-120 frames per second, with typical processing rates in the range of 5-30 frames per second.

The received video data may undergo initial input handling operations including decoding, timestamp extraction, and frame synchronization. Compressed video streams, such as H.264, H.265, or similar formats, may be decoded into individual frames using hardware or software codecs. Frames may be buffered in memory for short intervals, such as 10-1,000 milliseconds, more typically 50-500 milliseconds, to compensate for network jitter, packet reordering, or variations in frame arrival times. Buffer sizes may range from 1-200 frames depending on network conditions and processing latency targets. In implementations involving multiple cameras, timestamps or sequence identifiers may be used to maintain proper ordering of frames, with synchronization tolerances in the range of 0.5-200 milliseconds.

The system may also perform format normalization at this stage. Incoming frames with varying aspect ratios may be scaled or padded to standardized dimensions, such as 416×416, 640×640, 1280×720, or 1920×1080 pixels, prior to downstream processing. Color format conversions may include RGB to grayscale, YUV to RGB, or similar transformations. Grayscale conversion may reduce input dimensionality by approximately 30-70 percent compared to full-color representations. Frame rates from different sources may be adjusted to a target processing rate, such as 5-60 frames per second, by frame dropping, frame duplication, or temporal interpolation. Bit depths may range from 8-16 bits per channel, depending on the camera hardware. Metadata associated with each video source may include camera identifier, geographic coordinates within +1-10 meters, installation height (for example, 1.5-20 meters above ground), tilt angle (0-90 degrees), and field-of-view ranges of 30-180 degrees. Region-of-interest configurations associated with the camera may define spatial zones covering 5-100 percent of the frame area. These metadata parameters may be attached to the frame sequence and propagated through the pipeline to support subsequent region filtering, tracking, aggregation, and analytics operations.

At step 704, preprocessing and normalization are performed on frames of the video data at an edge device to condition the incoming imagery for consistent machine learning inference. These operations compensate for variability in camera hardware, environmental conditions, and transmission formats. Preprocessing may include resizing frames from source resolutions that may range from approximately 160×120 pixels to 7680×4320 pixels. Common resizing targets may include 320×320, 416×416, 512×512, 640×640, 800×800, 960×544, 1280×720, or 1920×1080 pixels. Scaling factors may range from 0.1× to 1.2× of original dimensions, depending on desired detection granularity and available processing capacity. Noise reduction may include spatial filters with kernel sizes in the range of 3×3 to 15×15 pixels or temporal smoothing over 2-10 consecutive frames to suppress sensor noise, compression artifacts, or low-light grain. Contrast and brightness adjustments may apply gain factors in the range of 0.5× to 2.0× and offset adjustments in the range of ±5-40 intensity levels on an 8-bit scale. Color space conversion may include RGB-to-grayscale, RGB-to-YUV, RGB-to-HSV, or similar transformations. Grayscale conversion may reduce per-frame data volume by approximately 33-67 percent. In some implementations, color channel normalization may scale pixel values to ranges such as [0,255], [0,1], or [−1,1], and may subtract channel-wise mean values in the range of 90-140 (8-bit scale) and divide by standard deviations in the range of 40-80.

Normalization may include padding operations to preserve aspect ratios, where padding may occupy 1-50 percent of the frame area, depending on source-to-target dimension differences. Alternatively, controlled non-uniform scaling may be applied with distortion tolerances in the range of 0-20 percent. Pixel intensity normalization may also include clipping or scaling operations to confine values within defined bounds, reducing outlier influence. Temporal normalization may be applied to align frame rates to a target processing rate, for example, reducing variable input rates of 1-120 frames per second to a standardized range of 5-60 frames per second. Frame selection intervals may range from processing every frame to every nth frame, where n may range from 1-10. These preprocessing and normalization steps reduce variance in model inputs, improve numerical stability, lower computational overhead, and enable consistent inference performance across diverse imaging conditions and hardware configurations.

At step 706, objects of interest are detected in the frames using one or more machine learning models executed at the edge device. The models may include convolutional neural network-based detectors configured for real-time inference, and may be optimized to process input frames at rates ranging from approximately 1-120 frames per second, more typically 5-60 frames per second, depending on hardware capacity and scene complexity. In some embodiments, multiple models may operate in parallel or in sequence, for example, a first model specialized for pedestrian detection, a second model for vehicles, and a third model for bicycles or other mobility devices. The detection models may operate on input resolutions standardized in the range of 224×224 to 1920×1920 pixels, with common operational ranges of 320×320 to 1280×1280 pixels. Each model may perform inference using 8-bit, 16-bit, or floating-point precision formats, balancing accuracy and computational load. The models may produce bounding regions representing detected objects, where bounding box widths and heights may range from 5-95 percent of frame width or height, depending on object distance and camera placement. Small objects may occupy approximately 0.05-2 percent of the frame area, medium objects 2-20 percent, and large objects 20-70 percent.

Detection confidence scores may be generated for each detection, expressed as probabilities in the range of 0.0-1.0, with operational thresholds for valid detections in the range of 0.2-0.95, depending on application sensitivity and noise tolerance. The class labels assigned to detections may include pedestrians, vehicles, bicycles, scooters, animals, carts, strollers, or other objects relevant to congestion monitoring. Object counts per frame may range from 0-5 in sparse environments, 5-50 in moderate traffic scenes, and 50-500 or more in high-density urban or event settings. Additional attributes may be inferred, such as orientation angles in the range of 0-360 degrees, estimated object heights or widths in pixel or real-world units, and object motion direction estimates between 0-360 degrees. Non-maximum suppression or similar post-processing may be applied using intersection-over-union thresholds in the range of 0.2-0.8 to eliminate redundant detections. The resulting detection outputs, including bounding regions, class labels, confidence scores, and optional attributes, are structured as metadata and forwarded to subsequent filtering and tracking stages, enabling scalable real-time object identification across diverse operational conditions.

At step 708, the detected objects are filtered based on object class and one or more regions of interest to constrain downstream processing to contextually relevant entities and spatial zones. The regions of interest may be defined using spatial masks that correspond to physical zones within the camera field of view, such as sidewalks, crosswalks, traffic lanes, parking areas, entrances, exits, queuing regions, corridors, or waiting areas. In some embodiments, a single camera view may include between 1-50 distinct masks, more typically 2-20 masks, each covering approximately 0.5-90 percent of the frame area, depending on scene layout and monitoring objectives. The filtering process may evaluate spatial overlap between detected object bounding regions and mask boundaries. Overlap criteria may include centroid inclusion within a mask, bounding box intersection, or area overlap thresholds in the range of 1-75 percent of the object's bounding area. Detections with overlap below a selected threshold, for example 5-40 percent, may be excluded. In some implementations, multiple masks may be hierarchically arranged, with primary masks defining broad zones (e.g., roadway vs. sidewalk) and secondary masks defining subzones (e.g., storefront frontage or crosswalk entry). Objects may be associated with one or multiple masks, depending on overlap percentages and mask priority values.

Class-based filtering may be applied concurrently. Object classes may include pedestrians, vehicles, bicycles, scooters, animals, carts, strollers, or other relevant entities. For pedestrian monitoring, only classes with confidence scores above thresholds such as 0.2-0.95 may be retained, while non-relevant classes are discarded. Conversely, in vehicle-focused monitoring, pedestrian detections may be excluded. In some embodiments, class filtering may reduce the effective object set by 20-95 percent, depending on scene composition. Temporal filtering may also be applied, for example, requiring that an object remain within a region for a minimum duration such as 0.1-5 seconds before being included in congestion metrics, thereby excluding transient or spurious detections. Combined spatial and class-based filtering may reduce the number of objects forwarded to tracking by about 10 to about 99 percent, decreasing the number of association operations, lowering memory allocation for track states, and reducing overall processor utilization while preserving relevant congestion-related data.

At step 710, the detected objects are associated across frames using motion and feature data to maintain persistent object identities over time. The association process evaluates candidate correspondences between detections in consecutive or near-consecutive frames using motion descriptors and appearance-based feature representations. Motion descriptors may include displacement vectors between object positions in successive frames, velocity estimates derived from position changes over time, and direction-of-travel angles. Displacement magnitudes may range from about 0 to about 150 pixels per frame in lower-resolution or slower scenes and from about 50 to about 300 pixels per frame in higher-resolution or faster-moving scenarios. Velocity estimates may correspond to real-world speeds in the range of about 0 to about 3 meters per second for pedestrians, about 2 to about 15 meters per second for bicycles or scooters, and about 10 to about 40 meters per second for vehicles. Directional headings may be represented as angles in the range of about 0 to about 360 degrees, with angular change rates from about 0 to about 90 degrees per second for gradual turns and from about 45 to about 180 degrees per second for sharper directional changes.

Appearance features may be extracted as embedding vectors from intermediate neural network layers, with dimensionalities ranging from about 64 to about 512 elements in lightweight configurations and from about 256 to about 2048 elements in higher-accuracy deployments. Similarity between feature vectors may be evaluated using cosine similarity or related metrics, with acceptable similarity thresholds from about 0.5 to about 0.95 for moderate-confidence matches and from about 0.85 to about 0.995 for high-confidence matches. Motion-based gating may restrict candidate associations to detections within spatial search radii ranging from about 5 to about 100 pixels in dense scenes and from about 50 to about 250 pixels in sparser or higher-speed scenarios. Temporal association windows may span from about 1 to about 5 frames for high-frame-rate inputs and from about 3 to about 20 frames to accommodate brief occlusions.

In moderate-density scenes, object counts per frame may range from about 5 to about 100, while in high-density environments such as urban events or transit hubs, counts may range from about 50 to about 1000 objects per frame. Association algorithms may evaluate from about 1 to about 30 candidate matches per detection in sparse scenes and from about 10 to about 50 candidates in denser scenes. By combining motion and appearance constraints, the system reduces identity switching and track fragmentation, which decreases the number of new track initializations and terminations. This reduces memory allocations for track states, improves cache locality, lowers processor cycles spent on corrective reassociation, reduces downstream aggregation overhead, and improves the accuracy of dwell time and flow metrics, thereby enhancing computational efficiency and scalability of the congestion monitoring system.

At step 712, multi-frame object tracks are generated to represent continuous trajectories of detected objects across successive frames. Each track is assigned a unique track identifier and may persist for durations ranging from about 0.05 seconds to about 20 minutes, depending on camera placement, scene scale, and object behavior. In pedestrian monitoring scenarios, a track may span from about 3 to about 5,000 frames, whereas in vehicular traffic monitoring, tracks may extend from about 2 to about 2,000 frames as vehicles move through the field of view. Each track may include a positional history comprising time-ordered spatial coordinates. Coordinates may be stored in image-space pixels or transformed into world-referenced coordinates. A single track may contain from about 3 to about 10,000 coordinate entries. Spatial displacement between consecutive entries may range from about 0 pixels for stationary objects to about 500 pixels per frame for fast-moving objects in high-resolution imagery. These position histories define trajectories used to compute path lengths ranging from about 0.1 meters to about 5,000 meters depending on scene coverage.

Timestamps associated with each position entry may be recorded with temporal resolutions ranging from about 0.5 milliseconds to about 500 milliseconds, corresponding to frame rates from about 2 to about 2,000 frames per second across different implementations. Using these timestamps and position histories, motion parameters may be derived. Velocity estimates may range from about 0 to about 60 meters per second, and acceleration values may range from about 0 to about 20 meters per second squared. Directional headings may span from about 0 to about 360 degrees, and directional change rates may range from about 0 to about 360 degrees per second. Confidence values stored per track may range from about 0.0 to about 1.0. Stable tracks may maintain confidence levels above about 0.75, while tracks experiencing intermittent detection or occlusion may drop to values between about 0.1 and about 0.6. Tracks with confidence below about 0.25 may be marked as tentative or terminated. Additional track attributes may include track age ranging from about 1 to about 10,000 frames, occlusion counters ranging from about 0 to about 200 frames, and region occupancy indicators covering from about 1 to about 50 regions per track.

Maintaining structured track records enables efficient downstream processing. Downstream modules can compute dwell times ranging from about 0.2 seconds to about 1,200 seconds, flow counts per region ranging from about 0 to about 10,000 objects per hour, and transition rates between zones in the range of about 0 to about 500 transitions per minute. This structured representation reduces redundant computations, stabilizes memory usage by limiting the number of active track states, improves cache locality, and supports scalable real-time congestion analytics across scenes containing from about 1 to about 5,000 concurrently tracked objects.

At step 714, structured inference results are stored in a memory as compact, structured metadata records rather than as raw video frames. These records may represent both individual detection events and multi-frame track updates, and may be organized in time-indexed and region-indexed data structures to enable efficient retrieval and aggregation. Each record may include fields such as a track identifier, object class label, region identifier, bounding region coordinates, centroid coordinates, motion vectors, timestamps, confidence values, and track state indicators such as active, tentative, or terminated.

The metadata representation significantly reduces data volume compared to raw imagery. A single raw video frame may occupy from about 0.5 megabytes to about 12 megabytes depending on resolution and encoding, whereas a corresponding metadata record for multiple objects in that frame may occupy from about 32 bytes to about 1 kilobyte. For example, a frame containing about 20 detected objects may be represented by about 20-200 metadata records totaling approximately 1-20 kilobytes, representing a reduction factor of about 50× to about 5,000× relative to frame storage. Individual track update records may include about 5-30 numerical values, such as position coordinates, velocity components, timestamps, and confidence scores. Memory buffers for storing structured inference data may range from about 1 megabyte to about 64 gigabytes depending on deployment scale and retention policies. In edge deployments, volatile memory may temporarily hold from about 1,000 to about 10 million metadata records for durations ranging from about 0.1 seconds to about 48 hours before aggregation or transmission. In centralized systems, persistent storage may archive aggregated records for periods ranging from about 1 hour to about several years, depending on analytical requirements.

Data write rates to memory may range from about 100 to about 10 million metadata records per second in high-density environments. Indexing structures such as hash tables or time-series indices may be used to enable retrieval by track identifier, region identifier, or time interval. For example, occupancy metrics for a given region may be computed by querying metadata entries within time windows of about 0.1 seconds to about 24 hours, while dwell time analysis may use track histories spanning from about 0.2 seconds to about 1,800 seconds. Because raw video frames are not stored, disk input/output operations are reduced by factors of about 10× to about 1,000×, memory bandwidth usage is lowered, and downstream analytics can operate directly on structured numerical data rather than image arrays. This reduces storage subsystem load, improves query performance, enhances cache efficiency, and enables scalable congestion analytics across deployments with from about 10 to about 10,000 concurrent video streams.

At step 716, the structured inference results are transmitted to a data ingestion service as compact metadata messages rather than raw image or video data. Transmission may occur using event-driven messaging, where individual detection or track update events are sent as they are generated, or using batched transmission, where groups of metadata records are accumulated and transmitted at defined intervals. Event-driven messages may be generated at rates ranging from about 10 to about 1,000,000 messages per second, depending on scene density and camera count. Batched transmissions may include batches containing from about 10 to about 1,000,000 metadata records, transmitted at intervals ranging from about 10 milliseconds to about 10 minutes.

Each metadata message may include fields such as track identifier, object class, region identifier, position coordinates, motion vectors, timestamps, and confidence values. Message sizes may range from about 32 bytes to about 2 kilobytes, depending on included attributes. Compared to raw video streams that may require bandwidth in the range of about 1 to about 100 megabits per second per camera, metadata transmission may require bandwidth in the range of about 10 kilobits per second to about 5 megabits per second for equivalent monitoring coverage. Transmission protocols may include lightweight messaging frameworks or streaming APIs supporting delivery latencies from about 1 millisecond to about 500 milliseconds. In multi-camera deployments involving from about 5 to about 5,000 cameras, aggregated metadata throughput may range from about 1,000 to about 50 million records per minute. By transmitting only structured inference results, the system reduces network load, minimizes latency, and enables scalable downstream analytics without requiring storage or transport of raw imagery.

At step 718, the structured inference results are aggregated to generate congestion metrics using time-indexed and region-indexed metadata derived from detection and tracking outputs. Aggregation may be performed over defined temporal windows ranging from about 0.1 seconds to about 24 hours, with common operational windows including about 1-10 seconds for real-time monitoring, about 1-60 minutes for short-term analysis, and about 1-30 days for historical trend evaluation. Spatial aggregation may occur across regions of interest defined by masks, where a single camera may include from about 1 to about 50 regions, and system-wide deployments may include from about 10 to about 10,000 regions. Within each time window and region, the aggregation module may compute object counts representing the number of active tracks present, which may range from about 0 to about 2,000 objects per region, depending on environment density. Flow rates may be calculated by counting track transitions across virtual boundaries, with rates ranging from about 0 to about 10,000 objects per hour. Dwell times may be derived from track entry and exit timestamps, with individual dwell durations ranging from about 0.2 seconds to about 3,600 seconds or more.

Additional aggregated metrics may include average velocity values ranging from about 0 to about 40 meters per second, directional distribution histograms covering about 0 to about 360 degrees, and density measures expressed as objects per square meter, ranging from about 0 to about 10. Aggregation processes may update metrics incrementally as new metadata arrives, supporting update rates from about 1 to about 10,000 metric updates per second. By summarizing large volumes of tracking metadata into compact congestion indicators, the aggregation stage reduces data dimensionality, improves query efficiency, and supports scalable analytics across deployments with from about 1 to about 5,000 concurrent video sources.

At step 720, anomalous data segments are filtered from the aggregated or pre-aggregated inference data to improve the reliability, consistency, and stability of congestion metrics. The anomaly filtering module may analyze time-series characteristics of detection counts, tracking continuity, confidence score distributions, motion vector statistics, and temporal consistency across one or more regions of interest. The filtering process may operate over temporal windows ranging from about 0.1 seconds to about 30 minutes, with rolling real-time windows of about 1-60 seconds and historical validation windows of about 5 minutes to about 24 hours. Statistical models such as moving averages, variance tracking, or threshold-based detection may be applied to identify deviations from expected behavioral patterns.

Camera obstruction events may be detected when object counts across one or more regions drop abruptly, for example, decreasing by about 50-100 percent within about 0.5-5 seconds, or when average detection confidence values fall below about 0.2-0.4 across most detections. Additional indicators may include sudden increases in image uniformity metrics or decreases in motion vector diversity, suggesting that the camera view is blocked by a stationary object. Such obstructions may last from about 0.5 seconds to about 10 minutes. The corresponding time intervals may be flagged and excluded from congestion calculations, preventing artificial dips in density or flow metrics.

Communication outages or frame delivery interruptions may be identified by irregular timestamp gaps, such as missing data intervals ranging from about 0.5 seconds to about 10 minutes, or by frame rate deviations exceeding about +20-80 percent of expected rates. For example, a camera expected to deliver 20 frames per second may temporarily drop to 2-5 frames per second due to network congestion. Buffer underflow or overflow conditions may also indicate transmission instability. Segments containing these gaps may be removed, interpolated with caution, or marked to prevent interpolation errors that could distort velocity, flow rate, or dwell time calculations.

Abnormal detection patterns may include sudden spikes or drops in detection counts beyond statistical thresholds, such as deviations exceeding about 2-6 standard deviations from rolling averages. Environmental effects such as glare, heavy rain, fog, snow, or rapid lighting changes may produce transient increases in false detections, with object counts rising by about 200-1,000 percent within seconds. Conversely, low-light conditions may reduce detection rates by about 30-90 percent. Additional anomalies may be indicated by irregular motion vector distributions, such as velocity magnitudes exceeding about 2-5 times normal values, or by unusually short track durations, for example, average track lengths falling from about 50 frames to fewer than about 5 frames. These segments may be flagged and excluded or down-weighted during aggregation. By filtering these anomalous segments, the system prevents corrupted or unreliable data from propagating into aggregated metrics and predictive models. This reduces the need for downstream reprocessing by about 10-70 percent, limits storage of invalid records, stabilizes time-series inputs, improves cache efficiency by reducing unnecessary track updates, and enhances overall computational efficiency and accuracy of congestion analytics across environments containing from about 1 to about 10,000 monitored regions.

At step 722, congestion-related outputs are provided to one or more downstream systems in the form of structured data streams, reports, or control signals derived from aggregated inference results. These outputs may be transmitted at update intervals ranging from about 50 milliseconds to about 10 minutes, depending on application requirements. In real-time monitoring deployments, updates may occur at rates of about 1-20 times per second, while in historical reporting scenarios, summaries may be generated every about 5 minutes to about 24 hours. Real-time density indicators may express the number of active tracked objects within a region, with values ranging from about 0 to about 2,000 objects per region, or may be normalized as objects per square meter in ranges from about 0 to about 10. Flow direction information may include vector-based summaries of dominant movement directions, with angular outputs spanning about 0-360 degrees and directional distributions updated over windows of about 1-60 seconds. Flow rate metrics may represent objects crossing virtual boundaries, with rates ranging from about 0 to about 20,000 objects per hour. Dwell statistics may include average and maximum residence times of objects within defined zones, with dwell durations ranging from about 0.2 seconds to about 3,600 seconds. These statistics may be used to assess queue lengths, waiting times, or customer engagement levels. Predictive trend data may include short-term forecasts spanning about 1 minute to about 2 hours and longer-term forecasts covering about 1 day to about 30 days. Forecast values may predict density changes of about +5-200 percent relative to baseline levels.

Downstream systems may include traffic management platforms that adjust signal timing when density thresholds of about 50-500 vehicles are exceeded, retail analytics systems that trigger staffing adjustments when pedestrian counts exceed about 100-1,000 persons per hour, or environmental control systems that modify ventilation rates when occupancy exceeds about 0.5-5 persons per square meter. Output message sizes may range from about 64 bytes to about 10 kilobytes per update, enabling scalable distribution across deployments with from about 1 to about 10,000 monitored regions. These outputs enable responsive system behavior while maintaining low bandwidth usage and efficient integration with external applications.

In some embodiments, the method further comprises applying multiple spatial masks to the video data to generate multiple independent region-based analytics without reprocessing the frames. A single frame sequence may be evaluated once by the detection and tracking stages, after which the resulting detection and track metadata are evaluated against a plurality of spatial masks. The masks may define distinct regions such as sidewalks, crosswalks, storefront zones, traffic lanes, or waiting areas. For example, a single camera view may include from about 2 to about 30 masks, each covering from about 1 percent to about 80 percent of the frame area. Detection coordinates and track positions may be tested against each mask geometry in memory, allowing the system to compute region-specific counts, dwell times, and flow metrics independently. Because mask evaluation operates on metadata rather than pixel data, multiple regional analytics streams are generated without repeating frame decoding or model inference, reducing processor utilization and latency.

In some embodiments, the method further comprises operating in a real-time processing mode in which frames are processed within bounded latency constraints. In this mode, end-to-end processing time from frame capture to output generation may be maintained within about 20 milliseconds to about 500 milliseconds. Frame processing rates may range from about 5 to about 60 frames per second, with buffering windows of about 10 to about 200 milliseconds to compensate for input variability. Real-time outputs such as density indicators or flow alerts may be delivered to downstream systems with update intervals of about 50 milliseconds to about 2 seconds. This bounded-latency operation enables responsive control actions in systems such as traffic signaling or crowd management.

In some embodiments, the method further comprises operating in a batch processing mode in which recorded video is processed independent of real-time constraints. Recorded footage stored locally or in remote storage may be processed at accelerated or variable speeds, for example from about 0.5× to about 20× real-time playback rates. Batch jobs may analyze video segments spanning from about 5 minutes to about 72 hours in duration. Because processing is not constrained by live latency requirements, computational resources may be scheduled to optimize throughput, and historical congestion patterns, dwell distributions, or trend analyses may be generated over extended time horizons.

In some embodiments, transmitting the structured inference results comprises sending event-driven metadata messages representing detection events. Each event-driven message may correspond to a detection or track update and may include fields such as track identifier, object class, region identifier, coordinates, timestamp, and confidence value. Event message sizes may range from about 32 bytes to about 1 kilobyte, and message transmission rates may range from about 10 to about 1,000,000 messages per second, depending on scene density and deployment scale. Event-driven messaging supports low-latency delivery of tracking information without transmitting raw imagery.

In some embodiments, transmitting the structured inference results comprises sending batched metadata representing trajectory segments. Batches may include aggregated track updates covering time spans from about 0.1 seconds to about 10 minutes and may contain from about 10 to about 1,000,000 metadata records per batch. Batch sizes may range from about 1 kilobyte to about 10 megabytes, depending on included attributes and aggregation intervals. Batched transmission reduces communication overhead by grouping multiple records into a single message and is well suited for historical analysis or environments where network efficiency is prioritized over immediate delivery.

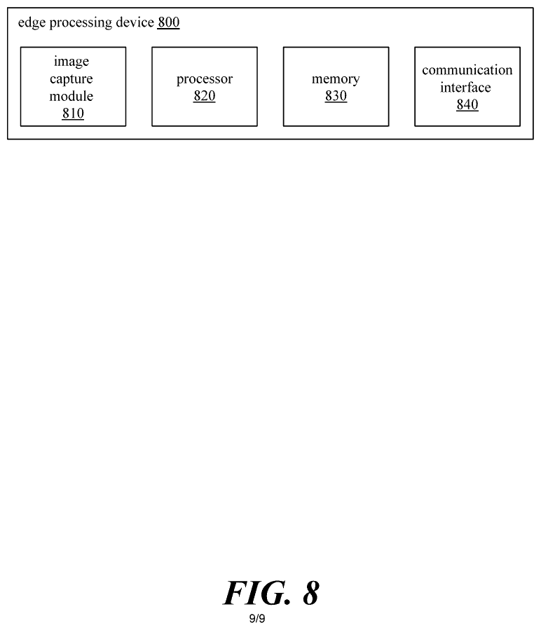

FIG. 8 illustrates an example edge processing device 800 configured for performing video analytics at or near a video capture location. In some embodiments, the edge processing device 800 includes an image capture module 810, a processor 820, a memory 830, and a communication interface 840. The image capture module 810 is configured to generate video frames. The module may include an imaging sensor, such as a CMOS or CCD sensor, optics defining a field of view, and supporting circuitry for image acquisition. The image capture module 810 may generate frames at resolutions ranging from about 320×240 pixels to about 7680×4320 pixels and at frame rates ranging from about 1 to about 120 frames per second. The module may also include on-board image conditioning components, such as automatic exposure control, gain adjustment, and white balance processing. In some embodiments, the image capture module 810 may receive image data from an external camera rather than an integrated sensor. The processor 820 may include one or more processing units, such as general-purpose processing cores, graphics processing units, digital signal processors, or neural processing units. The processor 820 is configured to execute instructions stored in the memory 830 to perform video analytics functions locally at the edge device 800.

The memory 830 stores instructions and data structures used in processing. The memory may include volatile memory, non-volatile memory, or a combination thereof, with storage capacities ranging from about 512 megabytes to about 64 gigabytes. When the stored instructions are executed by the processor 820, the processor performs preprocessing, object detection, region filtering, feature association, and multi-frame tracking on the generated video frames. Preprocessing may include resizing, normalization, and noise reduction. Object detection may involve one or more machine learning models generating bounding regions, class labels, and confidence values. Region filtering may apply spatial masks to retain only detections within relevant zones. Feature association and multi-frame tracking may maintain track state information, including positional histories, timestamps, and confidence metrics.

The communication interface 840 is configured to transmit structured inference artifacts to a remote data ingestion service. The structured artifacts may include metadata representing detections and tracks, such as track identifiers, object classes, region identifiers, positions, motion vectors, and timestamps. The communication interface 840 may support wired or wireless communication protocols and may transmit data at rates ranging from about 10 kilobits per second to about 10 megabits per second, depending on deployment scale. By transmitting compact metadata rather than raw video frames, the edge processing device 800 reduces bandwidth usage, lowers latency, and enables scalable distributed video analytics.

In some embodiments, the edge processing device is configured such that video frames generated by the image capture module are retained only in volatile memory during inference operations and are not stored in persistent storage. The volatile memory may include dynamic random-access memory or similar temporary storage resources, with frame retention durations ranging from about 1 millisecond to about 5 seconds, depending on buffering requirements and processing latency. Once preprocessing, detection, filtering, and tracking operations are completed for a given frame or sequence of frames, the corresponding image data may be overwritten or discarded. Persistent storage components, such as solid-state drives or flash memory, may therefore store only structured metadata and executable instructions, rather than raw image content. This configuration reduces long-term storage requirements by factors ranging from about 10× to about 10,000× relative to storing full-resolution video and limits exposure of image data beyond the immediate inference process.

In some embodiments, the communication interface is configured to transmit detection and tracking metadata at a lower bandwidth than would be required to transmit the corresponding video frames. Raw video streams may require bandwidths in the range of about 1 to about 100 megabits per second per camera, depending on resolution and frame rate, whereas metadata transmissions may require bandwidths in the range of about 10 kilobits per second to about 5 megabits per second. This reduction may correspond to bandwidth savings of about 20× to about 5,000×. The communication interface may transmit metadata using packet sizes ranging from about 32 bytes to about 2 kilobytes per message and may support update rates ranging from about 10 to about 1,000,000 metadata messages per second in high-density deployments.

In some embodiments, the structured inference artifacts transmitted by the device include bounding regions, object classifications, motion vectors, and track identifiers. Bounding regions may be represented as coordinate tuples defining detected object extents within a frame. Object classifications may include labels such as pedestrian, vehicle, bicycle, or other relevant categories. Motion vectors may include displacement components and direction values derived from multi-frame position changes. Track identifiers may uniquely reference object trajectories maintained across frames, with identifier values ranging from about 1 to about 10 million concurrent tracks in large-scale deployments. These structured artifacts enable downstream analytics and aggregation without requiring access to raw video imagery.

### Privacy and Data Handling

In some embodiments, the disclosed system is configured such that personally identifiable information is neither derived, stored, nor transmitted as part of normal system operation. The processing pipeline operates on video frames solely to generate structured inference artifacts, such as object locations, motion vectors, region identifiers, track identifiers, dwell times, and flow metrics. These artifacts represent abstracted metadata describing movement patterns and congestion characteristics and do not include biometric identifiers, facial recognition data, facial embeddings, identity-linked attributes, or cross-session identifiers. After inference is performed, raw video frames are not retained in persistent storage and are discarded from volatile memory once no longer required for immediate processing. Frame buffering durations in normal operation may range from about 1 millisecond to about 5 seconds, more typically from about 10 milliseconds to about 500 milliseconds.

In certain limited embodiments, a narrowly scoped short-term retention mode may be enabled during an initial onboarding, calibration, optimization, or auditing phase of system deployment. In this mode, a limited subset of video frames may be temporarily retained solely for the purpose of validating detection accuracy, analyzing edge cases, optimizing tracking parameters, or auditing system performance under real deployment conditions. Retention duration in this mode may be restricted to brief time intervals, such as from about 1 second to about 168 hours, more typically from about 10 seconds to about 72 hours, after which the retained video data is automatically deleted. Storage volume during this phase may be limited, for example, to about 100 megabytes to about 500 gigabytes, depending on deployment scale, and access may be restricted to authorized operators using role-based access controls.

In some implementations, the onboarding retention mode may operate on a sampling basis, retaining only a fraction of processed frames, for example, about 0.1 percent to about 20 percent of frames, or retaining frames associated with flagged edge cases, such as detection confidence below about 0.3-0.6, sudden detection count deviations exceeding about 2-5 standard deviations, or tracking discontinuities lasting about 1-20 frames. Frames associated with normal high-confidence detections may be excluded from retention. Even in this mode, system outputs remain anonymized metadata, and no identity linkage, facial template extraction, biometric profiling, or cross-camera re-identification is performed.

In some embodiments, the retention mode may be geographically or temporally constrained, such as enabled only during the first about 1 hour to about 14 days of deployment at a new location, or during scheduled maintenance windows. Automatic deletion policies may remove retained video in rolling intervals, such as every about 1-24 hours. Audit logs may record access events, with log sizes ranging from about 1 kilobyte to about 10 megabytes per day.

This limited retention mechanism provides technical benefits by enabling verification of model performance, reduction of tracking errors, calibration of region-specific parameters, and improvement of detection robustness across lighting ranges of about 1-100,000 lux and environmental conditions, including rain, fog, or glare. These improvements reduce false detection rates by about 5-50 percent, reduce track fragmentation events by about 10-70 percent, and decrease reprocessing cycles, thereby improving processor efficiency and system stability. The system then reverts to its primary privacy-preserving architecture based on metadata-only storage and anonymized outputs, with raw frames retained only in transient memory during inference.

### EXAMPLES

Embodiment 1. A method, comprising: acquiring, by one or more processors of an edge-enabled electronic device, video frames representing an environment, wherein acquiring comprises at least one of (i) capturing the video frames using an image sensor of the edge-enabled electronic device or (ii) receiving the video frames from an external video source; obtaining, by the one or more processors, a configuration that defines one or more regions of interest, each specified by a respective polygonal boundary in image coordinates, and one or more model-defined object classes of interest; preprocessing, by the one or more processors, the video frames to normalize one or more input characteristics comprising at least one of resolution, frame rate, or color characteristics; executing, by the one or more processors, at least one object detection model to produce, for a given frame, a set of detections, each comprising a location and a class label; filtering, by the one or more processors, the detections to determine, for each region of interest, an in-bound subset of detections that match at least one of the model-defined object classes of interest and satisfy a spatial inclusion test with respect to the polygonal boundary of the region of interest; associating, by the one or more processors, and for each region of interest, detections across successive frames to maintain track identities over a temporal window without storing raw video frames, wherein associating comprises computing an association cost using at least motion consistency and a detection history over the temporal window, and wherein associating applies class-aware tracking parameters that vary at least one of a matching threshold, a track initiation threshold, or a track persistence buffer based on an object class; generating, by the one or more processors, separate region-specific inference outputs for the regions of interest, the region-specific inference outputs comprising, for each region of interest, metrics derived from a plurality of detected objects within the region of interest, the metrics comprising at least one of object counts, flow direction, dwell time, or entry/exit events; and emitting, by the one or more processors, at least one real-time inference signal derived from at least one of the region-specific inference outputs to a downstream system configured to control or influence an operation within the environment.

Embodiment 2. The method of embodiment 1, wherein the configuration defines a plurality of regions of interest, and the processor generates a respective disjoint inference output stream for each region of interest from video frames.

Embodiment 3. The method of embodiment 1, wherein the polygonal boundary is defined using normalized coordinates relative to an image width and image height.

Embodiment 4. The method of embodiment 1, wherein associating detections across successive frames comprises computing, for respective detections, motion information comprising at least one motion vector magnitude and direction, and performing association based at least in part on the motion information.

Embodiment 5. The method of embodiment 1, wherein associating detections across successive frames further comprises extracting, for at least some detections, a feature representation or embedding vector and using a similarity between feature and class representations as an input to an association cost function.

Embodiment 6. The method of embodiment 1, wherein the processor maintains at least one tracking parameter comprising at least one of a match threshold, a new-track threshold, or a track buffer, and wherein the tracking parameter is selected based on a deployment-specific optimization process.

Embodiment 7. The method of embodiment 6, wherein the deployment-specific optimization process comprises: performing an auditing procedure that compares tracking outputs against observed conditions for a deployment site; and selecting tracking parameters using an exhaustive or near-exhaustive search over candidate parameters to satisfy one or more quality criteria.

Embodiment 8. The method of embodiment 7, wherein the quality criteria comprise at least one of reduced duplicate counts, reduced track fragmentation, improved temporal consistency, or reduced missed detections under occlusion.

Embodiment 9. The method of embodiment 1, further comprising storing, in a data store, multi-frame inference metadata comprising at least one of track identifiers, timestamps, class labels, region identifiers, motion vectors, or trajectory segments, without retaining raw video.

Embodiment 10. The method of embodiment 9, further comprising deleting, overwriting, or otherwise discarding the raw video frames after a period of time after generating the multi-frame inference metadata.

Embodiment 11. The method of embodiment 1, wherein emitting the at least one real-time inference signal comprises emitting a control message usable by one or more downstream systems to select, schedule, modify, or otherwise control content presentation or another environment-related operation based on at least one of region-specific object counts or region-specific class distributions, and wherein adjusting comprises modifying a region boundary to mitigate location-specific bias caused by at least one of camera viewpoint drift, construction changes, seasonal lighting changes, or persistent occlusion patterns.

Embodiment 12. The method of embodiment 1, further comprising adjusting at least one of the polygonal boundary or the model-defined object classes of interest based on detected environmental conditions or detected activity patterns.

Embodiment 13. The method of embodiment 1, further comprising: detecting anomalous inference outputs using at least one of temporal consistency checks, statistical thresholds, or rule-based criteria, and suppressing or normalizing the anomalous inference outputs prior to generating aggregated metrics.

Embodiment 14. The method of embodiment 1, further comprising: aggregating the region-specific inference outputs over a time window to generate higher-level metrics comprising at least one of hourly counts, directional flow rates, dwell distributions, or class-based distributions.

Embodiment 15. The method of embodiment 11, further comprising generating a predictive output that estimates a future activity level or demand level for at least one region of interest based on one or more aggregated metrics.

Embodiment 16. The method of embodiment 1, wherein the video frames are obtained from at least one of a live camera stream or a recorded video file, and wherein the preprocessing normalizes differences in at least one of a frame rate or a resolution between video sources.

Embodiment 17. An electronic device, comprising: an image sensor configured to capture video frames representing an environment; one or more processors; and memory storing instructions that, when executed by the one or more processors, cause the electronic device to: obtain a configuration that defines a plurality of regions of interest, each having a polygonal boundary and one or more model-defined object classes of interest; preprocess the video frames to normalize one or more input characteristics; execute at least one object detection model to produce detections, each comprising a location and a class label; for each region of interest, determine an in-bound subset of detections based on class membership and spatial inclusion within the polygonal boundary; associate in-bound detections across successive frames to maintain track identities over a temporal window without storing raw video frames; generate separate region-specific inference outputs for the plurality of regions of interest; and emit a real-time inference signal to a downstream system based on at least one of the region-specific inference outputs.

Embodiment 18. The electronic device of embodiment 17, wherein the memory stores tracking parameters and the one or more processors are configured to update the tracking parameters based on a deployment-specific optimization process.

Embodiment 19. The electronic device of embodiment 17, wherein the one or more processors are configured to store multi-frame inference metadata and delete raw video frames after the multi-frame inference metadata is generated.

Embodiment 20. The electronic device of embodiment 17, wherein the downstream system comprises a downstream consumer system, including at least one of a content playback system, an advertising system, an environmental control system, a monitoring system, or a real-time decision engine, executing on the electronic device or on a separate device, and wherein the real-time inference signal is configured to influence an operation of the downstream system based on at least one of region-specific counts or region-specific class distributions.

Embodiment 21. A computer-implemented system for monitoring and analyzing congestion trends, comprising: one or more video input interfaces configured to receive video data from at least one of a live video stream, a camera-based video source, and a recorded video source; an edge device comprising at least one processor and at least one memory storing instructions that, when executed, cause the at least one processor to perform frame-level inference on the video data; a processing pipeline executed by the edge device, the processing pipeline comprising a preprocessing module and a normalization module configured to normalize each frame of the video data; an object detection module configured to detect objects of interest within each normalized frame using one or more machine learning models; a class and region filtering module configured to filter the detected objects based on object class and one or more defined regions of interest; a motion vector and feature association module configured to associate the detected objects across frames based on motion and feature data; a multi-frame tracking module configured to generate object tracks over multiple frames; a multi-frame inference data store configured to store structured inference results generated by the processing pipeline; and a data ingestion service communicatively coupled to the multi-frame inference data store and configured to receive the structured inference results, the data ingestion service comprising: an aggregation module configured to aggregate tracking and detection data across time and across the one or more defined regions of interest; an anomaly filtering module configured to detect and filter anomalous data segments; and a reporting and prediction module configured to generate congestion-related metrics and predictive outputs; and one or more real-time content consumer systems configured to receive real-time inference outputs from the edge device.

Embodiment 22. The computer-implemented system of embodiment 21, wherein the preprocessing and normalization module is configured to perform at least one of frame resizing, grayscale transformation, and padding normalization to standardize input dimensions for the object detection module.

Embodiment 23. The computer-implemented system of embodiment 21, wherein the object detection module comprises at least one convolutional neural network-based detector configured to operate in an anchor-free detection framework.

Embodiment 24. The computer-implemented system of embodiment 21, wherein the one or more defined regions of interest comprise one or more spatial masks defining flexible regions of interest within a field of view.

Embodiment 25. The computer-implemented system of embodiment 24, wherein the one or more spatial masks are represented as computer-readable geometric data structures stored in the at least one memory and applied to coordinates of the detected objects rather than to raw image pixels.

Embodiment 26. The computer-implemented system of embodiment 21, wherein the motion vector and feature association module generates motion descriptors and appearance features for the detected objects and associates the detected objects across frames based on similarity thresholds.

Embodiment 27. The computer-implemented system of embodiment 21, wherein the multi-frame tracking module maintains track state information, including object position history, timestamps, and confidence values in the at least one memory.

Embodiment 28. The computer-implemented system of embodiment 21, wherein the edge device is configured to transmit structured metadata representing detection and tracking artifacts to the data ingestion service without transmitting corresponding raw video frames.

Embodiment 29. The computer-implemented system of embodiment 21, wherein the anomaly filtering module is configured to identify data segments associated with at least one of camera obstruction, communication outage, or abnormal detection distributions.

Embodiment 30. The computer-implemented system of embodiment 21, wherein the reporting and prediction module is configured to generate at least one of congestion density metrics, flow direction metrics, dwell time statistics, and trend forecasts.

Embodiment 31. A computer-implemented method for congestion monitoring, comprising: receiving video data from at least one video source; performing, at an edge device, preprocessing and normalization on frames of the video data; detecting objects of interest in the frames using one or more machine learning models; filtering the detected objects based on object class and one or more regions of interest; associating the detected objects across frames using motion and feature data; generating multi-frame object tracks; storing structured inference results in a memory; transmitting the structured inference results to a data ingestion service; aggregating the structured inference results to generate congestion metrics; filtering anomalous data segments; and providing congestion-related outputs to one or more downstream systems.

Embodiment 32. The computer-implemented method of embodiment 31, further comprising applying multiple spatial masks to the video data to generate multiple independent region-based analytics without reprocessing the frames.

Embodiment 33. The computer-implemented method of embodiment 31, further comprising operating in a real-time processing mode in which the frames are processed within bounded latency constraints.

Embodiment 34. The computer-implemented method of embodiment 31, further comprising operating in a batch processing mode in which recorded video is processed independent of real-time constraints.

Embodiment 35. The computer-implemented method of embodiment 31, wherein transmitting the structured inference results comprises sending event-driven metadata messages representing detection events.

Embodiment 36. The computer-implemented method of embodiment 31, wherein transmitting the structured inference results comprises sending batched metadata representing trajectory segments.

Embodiment 37. An edge processing device for video analytics, comprising: an image capture module configured to generate video frames; at least one processor; at least one memory storing instructions that, when executed by the at least one processor, cause the at least one processor to perform preprocessing, object detection, region filtering, feature association, and multi-frame tracking; and a communication interface configured to transmit structured inference artifacts to a remote data ingestion service.

Embodiment 38. The edge processing device of embodiment 37, wherein the video frames are retained only in volatile memory during inference and are not stored in persistent storage.

Embodiment 39. The edge processing device of embodiment 37, wherein the communication interface is configured to transmit detection and tracking metadata at a lower bandwidth than transmission of the video frames.

Embodiment 40. The edge processing device of embodiment 37, wherein the structured inference artifacts include bounding regions, object classifications, motion vectors, and track identifiers.

In certain embodiments, the apparatus and methods delineated above find application within a system comprising one or more integrated circuit (IC) devices, also referred to as integrated circuit packages or microchips, akin to the previously described processing system. Electronic design automation (EDA) and computer-aided design (CAD) software tools facilitate the design and fabrication of these IC devices. Typically, these design tools manifest as one or more software programs, comprising executable code designed to manipulate a computer system. Such manipulation involves the processing of code representative of circuitry within one or more IC devices, thereby executing at least a portion of a process aimed at designing or adapting a manufacturing system for fabricating said circuitry. This code encompasses instructions, data, or a combination thereof, and is stored in a computer-readable storage medium accessible to the computing system. The code representative of various design or fabrication phases may be stored and accessed from the same or different computer-readable storage media.

A computer-readable storage medium encompasses any non-transitory medium or combination thereof accessible by a computer system during operation to furnish instructions and/or data. These media include optical media (e.g., CDs, DVDs, Blu-Ray discs), magnetic media (e.g., floppy discs, magnetic tape, magnetic hard drives), volatile memory (e.g., RAM, cache), non-volatile memory (e.g., ROM, Flash memory), or microelectromechanical systems (MEMS)-based storage media. Such media may be embedded, fixedly attached, or removably attached to the computing system, or coupled to it via a wired or wireless network.

In some embodiments, specific aspects of the aforementioned techniques may be implemented by one or more processors within a processing system, executing software comprising one or more sets of executable instructions stored or otherwise tangibly embodied on a non-transitory computer-readable storage medium. This software includes instructions and certain data that, when executed by the processors, manipulate them to perform various techniques described earlier. The non-transitory computer-readable storage medium may encompass magnetic or optical disk storage devices, solid-state storage devices like Flash memory, caches, RAM, or other non-volatile memory devices. The executable instructions stored on this medium may be in source code, assembly language code, object code, or any other instruction format interpreted or executable by the processors.

It is important to note that not all the activities or elements described in the general description are obligatory, and further activities or elements may be added. The order in which activities are listed does not necessarily reflect the order of execution. Additionally, modifications and changes can be made without deviating from the scope of the disclosure as outlined in the claims. Therefore, the specification and figures should be interpreted in an illustrative rather than restrictive sense, encompassing all such modifications within the scope of the disclosure. Finally, the benefits, advantages, and solutions presented are not to be construed as critical, required, or essential features of any or all claims, and the disclosed subject matter may be practiced in equivalent manners apparent to those skilled in the art.

### Example 1: a Structured Representation of Data Using JavaScript Object Notation (JSON) Implemented by the System

This Example 1 presents a JSON implementation used by the system for tracking people in a video frame. It includes detection parameters, image dimensions, and flexible shapes defined by coordinates. Below is a detailed explanation of the structure and the purpose of each field.

```
### Fields:
1.**‘class ids’**(Array of integers)
  -**Description**: Represents the classes of objects being tracked. The integer ‘0’ refers
  to the class ID for ″people.″
  -**Example**: ‘[0]’ (indicating that the object of interest is ″people″).
2.**‘id’**(String)
  -**Description**: A unique identifier for the object being tracked.
  -**Example**:“people” (indicating the object type being tracked).
3.**‘tracking_params’**(Object)
  -**Description**: Contains parameters that define the behavior of the tracking
  algorithm. These values control various thresholds for initiating and continuing tracking.
  **Subfields:
  -**‘track_high_thresh’**(Float): The threshold above which tracking is considered
  highly confident.
  -**Example**: ‘0.38’
  -**‘track_low_thresh’**(Float): The threshold below which an object is not tracked.
  -**Example**: ‘0.0’
  -**‘new_track_thresh’**(Float): The threshold for starting a new track.
  -**Example**: ‘0.58’
  -**`match_thresh_first’**(Float): The matching threshold for the first pass in the
  matching process.
  -**Example**: `1.0’
  -**`match_thresh_second’**(Float): The matching threshold for the second pass in the
  matching process.
  -**Example**: ‘0.48’
  -**‘match_thresh_unconfirmed`**(Float): The threshold for matching unconfirmed
  tracks.
  -**Example**: ‘1.0’
  -**‘track buffer’**(Integer): The buffer used for maintaining tracks of objects for a
  given duration.
  -**Example**: ‘25’
4.**‘img_height’**(Integer)
  -**Description**: The height of the image or video frame in pixels.
  -**Example**: ‘1080’ (represents 1080p resolution).
5.**‘img_width’**(Integer)
  -**Description**: The width of the image or video frame in pixels.
  -**Example**: ‘1920’ (represents 1920p resolution).
6.**‘shapes’**(Array of objects)
  -**Description**: Represents one or more shapes or areas of interest within the frame.
  These areas are defined by coordinates, typically for tracking specific regions like a person or object's
  movement within a bounded space.
  **Subfields :**
  -**‘coordinates’**(Array of objects): A series of coordinates that define the shape or
  region in the image.
  **Coordinate Fields:**
  -**‘x’**(Float): The normalized x-coordinate, where ‘0’ represents the leftmost edge,
  and ‘1.0’ represents the rightmost edge of the image.
  -**Example**: ‘0.33’
  -**‘y’**(Float): The normalized y-coordinate, where ‘0’ represents the top, and ‘1.0’
  represents the bottom of the image.
    -**Example**: ‘1.0’
  ### Example of a ‘shapes’ object:
  ```json
  “shapes”: [
    {
      “coordinates:” [
        {“x”: 0.33, “y”: 1.0 },
        { “x”: 0.36, “y”: 0.78 },
        { “x”: 0.65, “y”: 0.78 },
        { “x”: 0.87, “y:” 0.74 },
        { “x”: 0.99, “y”: 0.71 },
        {“x”: 1.0, “y”: 1.0 }
      ]
    }
  ]
  ```
  -**Description**: Defines a shape (polygon) based on a series of six coordinates. These
  coordinates are normalized to the image's width and height.
  ### Usage:
```

This JSON structure could be used to describe tracking configurations, including specific objects or shapes of interest in video analytics. It includes detailed tracking parameters, frame dimensions, and the regions where tracking should occur. The structure supports flexible adaptation to different environments, such as retail analytics or pedestrian tracking.

```
### Full Example masking configuration to classify people based on gender and age with
the following class ids {0: “0-20_male”, 1: “21-40_male”″, 2: “41-60_male”″, 3: “61+_male”″, 4: “0-
20_female”, 5: “21-40_female”, 6: “41-60_female”, 7: “61+_female”}:
  ```json
  {
    “class_ids”: [0, 1, 2, 3, 4, 5, 6, 7],
    “id”: “gender_age”,
    “img_height”: 720,
    “img_width”: 1080,
    “tracking_params”: {
    “track_high_thresh”: 0.54,
    “track_low_thresh”: 0.38,
    “new_track_thresh”: 0.79,
    “match_thresh_first”: 0.92,
    “match_thresh_second”: 0.55,
    “match_thresh+unconfirmed”: 0.62,
    “track_buffer”: 25
  },
  “shapes”: [
    {
      “coordinates”: [
        {
          “x”: 0.0,
          “y”: 0.94
        }.
        {
          “x”: 1.0,
          “y”: 0.94
        },
        {
          “x”: 1.0,
          “y”: 1.0
        },
        [
          “x”: 0.0,
          “y”: 1.0
        }
      ]
    }
  ]
}```
```

What is claimed is:

1. A method, comprising:
acquiring, by one or more processors of an edge-enabled electronic device, video frames representing an environment, wherein acquiring comprises at least one of (i) capturing the video frames using an image sensor of the edge-enabled electronic device or (ii) receiving the video frames from an external video source;
obtaining, by the one or more processors, a configuration that defines one or more regions of interest each specified by a respective polygonal boundary in image coordinates, and one or more model-defined object classes of interest;
preprocessing, by the one or more processors, the video frames to normalize one or more input characteristics comprising at least one of resolution, frame rate, or color characteristics;
executing, by the one or more processors, at least one object detection model to produce, for a given frame, a set of detections each comprising a location and a class label;
filtering, by the one or more processors, the detections to determine, for each region of interest, an in-bound subset of detections that match at least one of the model-defined object classes of interest and satisfy a spatial inclusion test with respect to the polygonal boundary of the region of interest;
associating, by the one or more processors and for each region of interest, detections across successive frames to maintain track identities over a temporal window without storing raw video frames, wherein associating comprises computing an association cost using at least motion consistency and a detection history over the temporal window, and wherein associating applies class-aware tracking parameters that vary at least one of a matching threshold, a track initiation threshold, or a track persistence buffer based on an object class;
generating, by the one or more processors, separate region-specific inference outputs for the regions of interest, the region-specific inference outputs comprising, for each region of interest, metrics derived from a plurality of detected objects within the region of interest, the metrics comprising at least one of object counts, flow direction, dwell time, or entry/exit events; and
emitting, by the one or more processors, at least one real-time inference signal derived from at least one of the region-specific inference outputs to a downstream system configured to control or influence an operation within the environment.

2. The method of claim 1,
wherein the configuration defines a plurality of regions of interest and the processor generates a respective disjoint inference output stream for each region of interest from video frames.

3. The method of claim 1,
wherein the polygonal boundary is defined using normalized coordinates relative to an image width and image height.

4. The method of claim 1,
wherein associating detections across successive frames comprises computing, for respective detections, motion information comprising at least one motion vector magnitude and direction, and performing association based at least in part on the motion information.

5. The method of claim 1,
wherein associating detections across successive frames further comprises extracting, for at least some detections, a feature representation or embedding vector and using a similarity between feature and class representations as an input to an association cost function.

6. The method of claim 1,
wherein the processor maintains at least one tracking parameter comprising at least one of a match threshold, a new-track threshold, or a track buffer, and wherein the tracking parameter is selected based on a deployment-specific optimization process.

7. The method of claim 6,
wherein the deployment-specific optimization process comprises:
performing an auditing procedure that compares tracking outputs against observed conditions for a deployment site; and
selecting tracking parameters using an exhaustive or near-exhaustive search over candidate parameters to satisfy one or more quality criteria.

8. The method of claim 7,
wherein the quality criteria comprise at least one of reduced duplicate counts, reduced track fragmentation, improved temporal consistency, or reduced missed detections under occlusion.

9. The method of claim 1,
further comprising storing, in a data store, multi-frame inference metadata comprising at least one of track identifiers, timestamps, class labels, region identifiers, motion vectors, or trajectory segments, without retaining raw video.

10. The method of claim 9,
further comprising deleting, overwriting, or otherwise discarding the raw video frames after a period of time after generating the multi-frame inference metadata.

11. The method of claim 1,
wherein emitting the at least one real-time inference signal comprises emitting a control message usable by one or more downstream systems to select, schedule, modify, or otherwise control content presentation or another environment-related operation based on at least one of region-specific object counts or region-specific class distributions, and
wherein adjusting comprises modifying a region boundary to mitigate location-specific bias caused by at least one of camera viewpoint drift, construction changes, seasonal lighting changes, or persistent occlusion patterns.

12. The method of claim 1, further comprising adjusting at least one of the polygonal boundary or the model-defined object classes of interest based on detected environmental conditions or detected activity patterns.

13. The method of claim 1, further comprising:
detecting anomalous inference outputs using at least one of temporal consistency checks, statistical thresholds, or rule-based criteria, and suppressing or normalizing the anomalous inference outputs prior to generating aggregated metrics.

14. The method of claim 1, further comprising:
aggregating the region-specific inference outputs over a time window to generate higher-level metrics comprising at least one of hourly counts, directional flow rates, dwell distributions, or class-based distributions.

15. The method of claim 11,
further comprising generating a predictive output that estimates a future activity level or demand level for at least one region of interest based on one or more aggregated metrics.

16. The method of claim 1,
wherein the video frames are obtained from at least one of a live camera stream or a recorded video file, and wherein the preprocessing normalizes differences in at least one of a frame rate or a resolution between video sources.

17. An electronic device, comprising:
an image sensor configured to capture video frames representing an environment;
one or more processors; and
memory storing instructions that, when executed by the one or more processors, cause the electronic device to:
obtain a configuration that defines a plurality of regions of interest each having a polygonal boundary and one or more model-defined object classes of interest;
preprocess the video frames to normalize one or more input characteristics;
execute at least one object detection model to produce detections each comprising a location and a class label;
for each region of interest, determine an in-bound subset of detections based on class membership and spatial inclusion within the polygonal boundary;
associate in-bound detections across successive frames to maintain track identities over a temporal window without storing raw video frames;
generate separate region-specific inference outputs for the plurality of regions of interest; and
emit a real-time inference signal to a downstream system based on at least one of the region-specific inference outputs.

18. The electronic device of claim 17,
wherein the memory stores tracking parameters and the one or more processors are configured to update the tracking parameters based on a deployment-specific optimization process.

19. The electronic device of claim 17,
wherein the one or more processors are configured to store multi-frame inference metadata and delete raw video frames after the multi-frame inference metadata is generated.

20. The electronic device of claim 17,
wherein the downstream system comprises a downstream consumer system, including at least one of a content playback system, an advertising system, an environmental control system, a monitoring system, or a real-time decision engine, executing on the electronic device or on a separate device, and wherein the real-time inference signal is configured to influence an operation of the downstream system based on at least one of region-specific counts or region-specific class distributions.

21. A computer-implemented system for monitoring and analyzing congestion trends, comprising:
one or more video input interfaces configured to receive video data from at least one of a live video stream, a camera-based video source, and a recorded video source;
an edge device comprising at least one processor and at least one memory storing instructions that, when executed, cause the at least one processor to perform frame-level inference on the video data;
a processing pipeline executed by the edge device, the processing pipeline comprising a preprocessing module and a normalization module configured to normalize each frame of the video data;
an object detection module configured to detect objects of interest within each normalized frame using one or more machine learning models;
a class and region filtering module configured to filter the detected objects based on object class and one or more defined regions of interest;
a motion vector and feature association module configured to associate the detected objects across frames based on motion and feature data;
a multi-frame tracking module configured to generate object tracks over multiple frames;
a multi-frame inference data store configured to store structured inference results generated by the processing pipeline; and
a data ingestion service communicatively coupled to the multi-frame inference data store and configured to receive the structured inference results, the data ingestion service comprising:
an aggregation module configured to aggregate tracking and detection data across time and across the one or more defined regions of interest;
an anomaly filtering module configured to detect and filter anomalous data segments; and
a reporting and prediction module configured to generate congestion-related metrics and predictive outputs; and
one or more real-time content consumer systems configured to receive real-time inference outputs from the edge device.

22. The computer-implemented system of claim 21, wherein the preprocessing and normalization module is configured to perform at least one of frame resizing, grayscale transformation, and padding normalization to standardize input dimensions for the object detection module.

23. The computer-implemented system of claim 21, wherein the object detection module comprises at least one convolutional neural network-based detector configured to operate in an anchor-free detection framework.

24. The computer-implemented system of claim 21, wherein the one or more defined regions of interest comprise one or more spatial masks defining flexible regions of interest within a field of view.

25. The computer-implemented system of claim 24, wherein the one or more spatial masks are represented as computer-readable geometric data structures stored in the at least one memory and applied to coordinates of the detected objects rather than to raw image pixels.

26. The computer-implemented system of claim 21, wherein the motion vector and feature association module generates motion descriptors and appearance features for the detected objects and associates the detected objects across frames based on similarity thresholds.

27. The computer-implemented system of claim 21, wherein the multi-frame tracking module maintains track state information including object position history, timestamps, and confidence values in the at least one memory.

28. The computer-implemented system of claim 21, wherein the edge device is configured to transmit structured metadata representing detection and tracking artifacts to the data ingestion service without transmitting corresponding raw video frames.

29. The computer-implemented system of claim 21, wherein the anomaly filtering module is configured to identify data segments associated with at least one of camera obstruction, communication outage, or abnormal detection distributions.

30. The computer-implemented system of claim 21, wherein the reporting and prediction module is configured to generate at least one of congestion density metrics, flow direction metrics, dwell time statistics, and trend forecasts.

31. A computer-implemented method for congestion monitoring, comprising:
receiving video data from at least one video source;
performing, at an edge device, preprocessing and normalization on frames of the video data;
detecting objects of interest in the frames using one or more machine learning models;
filtering the detected objects based on object class and one or more regions of interest;
associating the detected objects across frames using motion and feature data;
generating multi-frame object tracks;
storing structured inference results in a memory;
transmitting the structured inference results to a data ingestion service;
aggregating the structured inference results to generate congestion metrics;
filtering anomalous data segments; and
providing congestion-related outputs to one or more downstream systems.

32. The computer-implemented method of claim 31, further comprising applying multiple spatial masks to the video data to generate multiple independent region-based analytics without reprocessing the frames.

33. The computer-implemented method of claim 31, further comprising operating in a real-time processing mode in which the frames are processed within bounded latency constraints.

34. The computer-implemented method of claim 31, further comprising operating in a batch processing mode in which recorded video is processed independent of real-time constraints.

35. The computer-implemented method of claim 31, wherein transmitting the structured inference results comprises sending event-driven metadata messages representing detection events.

36. The computer-implemented method of claim 31, wherein transmitting the structured inference results comprises sending batched metadata representing trajectory segments.

37. An edge processing device for video analytics, comprising:
an image capture module configured to generate video frames;
at least one processor;
at least one memory storing instructions that, when executed by the at least one processor, cause the at least one processor to perform preprocessing, object detection, region filtering, feature association, and multi-frame tracking; and
a communication interface configured to transmit structured inference artifacts to a remote data ingestion service.

38. The edge processing device of claim 37, wherein the video frames are retained only in volatile memory during inference and are not stored in persistent storage.

39. The edge processing device of claim 37, wherein the communication interface is configured to transmit detection and tracking metadata at a lower bandwidth than transmission of the video frames.

40. The edge processing device of claim 37, wherein the structured inference artifacts include bounding regions, object classifications, motion vectors, and track identifiers.
